(19) United States
(12) Patent Application Publication
(10) Pub. No.: US 2005/0270944 A1
(43) Pub. Date: Dec. 8, 2005

(54) Information recording medium, recording apparatus and method for the same, reproducing apparatus and method for the same, computer program product for record or reproduction control, and data structure including control signal

(76) Inventors: Masayoshi Yoshida, Saitama (JP); Takeshi Koda, Saitama (JP); Keiji Katata, Saitama (JP)

Correspondence Address: YOUNG & THOMPSON, 745 SOUTH 23RD STREET, 2ND FLOOR, ARLINGTON, VA, 22202, US

(21) Appl. No.: 11/125,271

(22) Filed: May 10, 2005

(30) Foreign Application Priority Data
May 10, 2004 (JP) 2004-140343

(51) Int. Cl. G11B 5/09; G11B 7/00

(52) U.S. Cl. 369/53.17; 369/47.14; 369/53.15

(57) ABSTRACT

An information recording medium is provided with: a user data area to record therein record data; a spare area to alter thereto one portion of the user data area, along with defect management in the user data area; and a defect management area to record therein defect management information which includes first information and second information, the first information indicating a correspondence relationship between an evacuation source address in the user data area and an evacuation destination address in the spare area, along with alternative recording in the user data area based on the defect management, the second information indicating a correspondence relationship between an alternative source address in the spare area and an alternative destination address in the spare area, along with alternative recording in the spare area based on the defect management.

### BACKGROUND OF THE INVENTION

1. Field of the Invention

The present invention relates to: an information recording medium, such as a write-once-type or rewritten-type DVD; an apparatus for and a method of recording information onto the information recording medium, such as a DVD recorder; an apparatus for and a method of reproducing the information recorded on the information recording medium; a computer program product for record or reproduction control; and a data structure including a control signal for record or reproduction control.

2. Description of the Related Art

As a technique of improving the reliability of the recording and reading of record data on a high-density recording medium, such as an optical disc, a magnetic disc, and a magneto optical disc, there is defect management. Namely, if there are scratches or dusts, or deterioration (which are collectively referred to as a “defect”) on the recording medium, the data to be recorded or already recorded at the position of the defect is recorded into another area on the recording medium (which is referred to as a “spare area”). As described above, by evacuating to the spare area the record data which is possibly imperfectly or incompletely recorded or read because of the defect, it is possible to improve the reliability of the recording and reading of the record data (refer to Japanese Patent Application Laid Open NO. 11-185390).

In general, a defect list is generated to perform the defect management. On the defect list, there are recorded address information for indicating the position of a defect on the recording medium (which is herein referred to as an “evacuation source address”, as occasion demands), and address information for indicating a position in the spare area to which the data to be recorded or already recorded at the position of the defect is evacuated (e.g. a recording position in the spare area: which is herein referred to as an “evacuation destination address”, as occasion demands). The defect list is generated when the recording medium is initialized or formatted. Moreover, the defect list is also generated when the record data is recorded onto the recording medium. When the record data is recorded and rewritten several times, the record data is recorded and rewritten. If a defect is found and the data is evacuated, the defect list is generated or updated. When the record data is recorded onto the recording medium, the defect list is referred to. This allows the recording of the record data onto the recording medium away from the position of a defect. On the other hand, the defect list is also referred to when the record data recorded on the recording medium is reproduced.

As described above, by virtue of the defect management, it is possible to surely read both the record data recorded in a normal recording area and the record data recorded in the spare area because of the presence of a defect, on the basis of the defect list.

On the other hand, if a smaller amount of record data than 1 Error Correcting Code (ECC) block is recorded, so-called Read Modify Write (RMW) processing is performed under the control of a recording apparatus. Here, the “RMW processing” is a recording operation, provided with three processing. More specifically, in the RMW processing, as a first step, the record data is stored into a buffer and read from the recording medium, by the smallest recording unit, such as 1 sector and 1 ECC block. As a second step, a correction, such as the addition of another data, is made to one portion of the read record data. As a third step, the corrected record data is recorded at the same address on the recording medium, by the smallest recording unit, such as 1 sector and 1 ECC block. Incidentally, if the buffering of the record data is not sufficient, the RMW processing is continuously performed.

According to the recording apparatus provided with a function of the defect management described above, even if a read error in which an error correction is impossible occurs in the first step in the RMW processing, the same defect management makes it possible to surely read both the record data recorded in the normal recording area and the record data recorded in the spare area because of the presence of the defect, on the basis of the defect list.

However, if the both techniques of the defect management and the RMW processing as described above are applied to the information recording medium, such as the write-once-type or rewritten type DVD, in the case where the defect continuously occurs, it is necessary to evacuate, to the spare area, the record data recorded in the normal recording area which is possibly imperfectly or incompletely recorded or read because of the defect. Moreover, it is also necessary to evacuate the record data recorded in the spare area to another spare area. As described above, in the case where the defect continuously occurs, if the evacuation of the record data is continuously performed in a plurality of spare areas by the defect management, there is such a technical problem that it is hardly possible or impossible to go back in time and recognize (or obtain) the evacuation source address where the defect occurs, on the basis of the defect list. Thus, there is such a technical problem that it is impossible to go back in time and perform the RMW processing again, with respect to the evacuation source address of the past.

### SUMMARY OF THE INVENTION

It is therefore an object of the present invention to provide: an information recording medium which can re-use the record data recorded by the defect management; a recording apparatus for and a recording method of recording the record data onto the information recording medium; a reproducing apparatus for and a reproducing method of reproducing the record data recorded on the information recording medium; a computer program product used for the recording apparatus or reproducing apparatus; and a data structure including a control signal for record or reproduction control.

(Information Recording Medium)

The above object of the present invention can be achieved by an information recording medium provided with: a user data area to record therein record data; a spare area to alter thereto one portion of the user data area, along with defect management in the user data area; and a defect management area to record therein defect management information which includes first information and second information, the first information indicating a correspondence relationship between an evacuation source address in the user data area and an evacuation destination address in the spare area, along with alternative recording in the user data area based on the defect management, the second information indicating a correspondence relationship between an alternative source address in the spare area and an alternative destination address in the spare area, along with alternative recording in the spare area based on the defect management.

According to the information recording medium of the present invention, it is possible to record the record data into the user data area. The record data is mainly the object of reproduction or execution, and includes a series of contents, such as image data, audio data, text data, contents data, and a computer program. Moreover, it is possible to properly perform the recording and reproduction of the record data recorded in the user data area, by recording the following information into a control information recording area described later: information for indicating the attribute and type of the information recording medium; information for address management of the record data; information for controlling the recording and reading operations of a drive apparatus; or the like.

In the defect management area, the defect management information of the user data area is recorded. Here, the “defect management information” of the present invention is used for a so-called alternative recording operation based on the defect management. The “defect management information” includes: information about a pair which indicates a correspondence relationship between the evacuation source address in the user data area and the evacuation destination address in the spare area; information about an alternative list entry (a defect list entry), or the like. Specifically, the “address” of the present invention means position information which can be specified by a unit of ECC (Error Correcting Code) block or sector. The defect management area is intended to record therein the defect management information until the information recording medium of the present invention is finalized, for example. Therefore, for example, in the case of the reproduction of the information recording medium, until it is finalized, the defect management is performed by reading the defect management information from the defect management area.

Particularly, in the present invention, the defect management information includes therein the first information and the second information. The first information indicates the correspondence relationship between the evacuation source address in the user data area and the evacuation destination address in the spare area, along with the alternative recording based on the defect management. The second information indicates the correspondence relationship between the alternative source address in the spare area and the alternative destination address in the spare area, along with the alternative recording in the spare area. As described above, the defect management information is related to the alternative recording among a plurality of spare areas, in addition to the alternative recording between the user data area and the spare area.

As described above, even if there is a defect at the address of the desired ECC block in the RMW processing and the record data cannot be read, it is possible to refer to the defect management information and go back in time and obtain the history of the alternative recording. Thus, it is possible to reproduce again the record data which is recorded at the position of the evacuation source address (or the alternative source address) on the basis of the defect management (or the alternative recording in the spare area). Namely, it is possible to go back in time and reproduce the record data of the past again, which prevents from failing to read the desired record data. Moreover, if it becomes possible to reproduce the data because of cleaned finger prints, a change in the reading condition of a recording apparatus, or for similar reasons, it is possible to reproduce the record data again. Therefore, a read error is not inputted into the Central Processing Unit (CPU) of the recording apparatus.

Consequently, it is possible to reuse a particular ECC block if there is a need to trace back through a history or generations and reproduce the record data again, such as an old version of file, by using application of performing the version management of the record data.

In one aspect of the information recording medium of the present invention, the defect management information further includes first state information which indicates whether or not the alternative recording in the user data area or the alternative recording in the spare area is completed.

According to this aspect, the defect management information includes the first state information in association with a pair of the evacuation source address (the alternative source address) and the evacuation destination address (the alternative destination address). Therefore, it is possible to unify a format required for the expression of a single defect list. For example, it is possible to sort by using the first state information as a key.

In this aspect, the defect management information may indicate the first information if the first state information is in a first state, and that the defect management information may indicate the second information if the first state information is in a second state.

By such construction, the defect management information may indicate the first information described above if the first state information is in the first state which is “already evacuated”. On the other hand, the defect management information may indicate the second information described above if the first state information is in the second state which is “cannot be used”. Therefore, it is possible to unify a format required for the expression of a single defect list. For example, it is possible to sort by using the first state information as a key. More specifically, it is possible to sort by using the alternative destination address or the alternative source address in the spare area based on the alternative recording in the spare area, as the key. As described above, it is possible to facilitate handling, such as the updating, rearrangement or sorting, and generation of the defect list.

In another aspect of the information recording medium of the present invention, the defect management information further includes second state information which indicates a record state of a first position at the evacuation source address corresponding to the first information or which indicates a record state of a second position at the alternative source address corresponding to the second information.

According to this aspect, the defect management information includes the second state information in association with a pair of the evacuation source address (the alternative source address) and the evacuation destination address (the alternative destination address). The “second state information” here indicates the record state of the evacuation destination address in the spare area based on the defect management, or the alternative source address in the spare area based on the alternative recording in the spare area. More specifically, the defect management information may indicate the record state, such as recorded or unrecorded, at the alternative destination address in the spare area based on the defect management if the “first state information” indicates “already evacuated”. On the other hand, the defect management information may indicate the record state, such as recorded or unrecorded, at the alternative source address in the spare area based on the alternative recording in the spare area if the “first state information” indicates “cannot be used”.

As described above, by reading the second state information from the defect list, it is possible to directly access the desired address, such as a sector number, and it is possible to reduce an access time of accessing the desired record data, such as files.

In another aspect of the information recording medium of the present invention, the defect management area is provided with a definite defect management area in addition to or in place of a temporary defect management area.

According to this aspect, the defect management information may be recorded a plurality of times repeatedly into the temporary defect management area, or the definite defect management area. Here, the temporary defect management area is intended to record therein the defect management information until the information recording medium of the present invention is finalized, for example. Moreover, the definite defect management area is intended to record therein the defect management information if the information recording medium of the present invention is finalized, if the defect management information is updated any more, and if the content of the defect management information is determined. By this, it is possible to certainly hold the defect management information on the information recording medium.

In addition, it may be constructed such that the areal size of the temporary defect management area is set, and that the position of the user data area is set in accordance with the set areal size of the temporary defect management area. For example, by setting the temporary defect management area to be large, it is possible to record more defect management information into the temporary defect management area. Namely, in this case, the defect management information can be recorded in series many times, so that even if the number of the updating increases, it is possible to record and hold each defect management information. By this, even if the information recording medium is used in a bad environment where a defect easily occurs frequently, it is possible to maintain or improve the reliability of the recording and reproduction of the record data. Moreover, for example, it is possible to increase the number of recording the defect management information with the same content repeatedly, and it is possible to increase the certainty of recording and holding the defect management information. On the other hand, by setting the temporary defect management area to be small, it is possible to reserve or ensure the large user data area by that much. Thus, it is possible to increase the substantial recording capacity of the information recording medium. If the setting of the range of the temporary defect management area is entrusted to a user, it is possible to properly set the temporary defect management area in accordance with the use of the information recording medium by the user.

In this aspect, it may be constructed such that the information recording medium is further provided with a control information recording area to record therein information for controlling at least one of recording and reading into the user data area, the control information recording area including a definite defect management area to record therein defect management information of the user data area.

By such construction, it is possible to maintain the compatibility between the information recording medium of the present invention and a rewritable-type information recording medium, for example.

For example, in the case of the reproduction of the information recording medium after the finalizing, the defect management is performed by reading the defect management information from the definite defect management area. In addition, the definite defect management area is placed in the control information recording area. In most rewritable-type information recording media which are generally spread and on which a recording apparatus manages the defect list, the defect management area is placed in the control information recording area. Moreover, most rewritable-type information recording media which will be developed from now on will predictably have such a structure that the defect management area is placed in the control information recording area. Therefore, because the same structure as that of the general rewritable-type information recording medium is adopted in the present invention, it is possible to provide the compatibility with the rewritable-type information recording medium having the same standard. As a result, on various reproducing apparatuses of a reproduce-only type or a rewritable-type, it is possible to properly reproduce the record data on the information recording medium of the present invention. Therefore, there is an extremely great benefit in terms of easy diffusion to public.

In another aspect of the information recording medium of the present invention, at least one of the evacuation source address, the evacuation destination address, the alternative source address, and the alternative destination address is specified by an absolute address in the user data area or a relative address based on a predetermined position.

According to this aspect, it is possible to reduce a processing load related to an address calculation in the recording and reproduction operations of a recording/reproducing apparatus described later, by that at least one of the evacuation source address, the evacuation destination address, the alternative source address, and the alternative destination address is specified by the absolute address, such as a physical address in the user data area. Therefore, it is possible to improve processing performance related to the recording and reproduction operations (e.g. speed-up or the like).

On the other hand, it is possible to reduce the data amount of the defect management information by that at least one of the evacuation source address, the evacuation destination address, the alternative source address, and the alternative destination address is specified by the relative address based on a predetermined position in the user data area.

(Recording Apparatus and Method)

The above object of the present invention can be also achieved by a recording apparatus for recording record data onto an information recording medium provided with: (i) a user data area to record therein the record data; (ii) a spare area to alter thereto one portion of the user data area, along with defect management in the user data area; and (iii) a defect management area to record therein defect management information which includes first information and second information, the first information indicating a correspondence relationship between an evacuation source address in the user data area and an evacuation destination address in the spare area, along with alternative recording in the user data area based on the defect management, the second information indicating a correspondence relationship between an alternative source address in the spare area and an alternative destination address in the spare area, along with alternative recording in the spare area based on the defect management, the recording apparatus provided with: a defect management information generating device for generating or updating the defect management information; and a recording device for recording the record data and the generated or updated defect management information.

According to the recording apparatus of the present invention, it is possible to properly record the record data onto the information recording medium of the present invention described above, by using an optical pickup, a controller for controlling the optical pickup, and the like, for example.

Specifically, at first, the recording device records the record data into the user data area on the information recording medium. On the other hand, on the recording apparatus of the present invention, the defect management information generating device generates the defect management information that includes the above-described defect list entry (the alternative list entry) for indicating the position of a defect existing on the information recording medium. The generated or obtained defect management information may be stored into a memory device, which includes a memory, such as a RAM.

At this time, in the present invention, the defect management information generating device generates the defect management information such that the defect management information includes therein the first information and the second information. The first information indicates the correspondence relationship between the evacuation source address in the user data area and the evacuation destination address in the spare area, along with the alternative recording based on the defect management. The second information indicates the correspondence relationship between the alternative source address in the spare area and the alternative destination address in the spare area, along with the alternative recording in the spare area.

Then, the recording device records the defect management information generated in this manner, into the defect management area on the information recording medium. The recording device can record the defect management information into the defect management area in various timing. For example, the considerable timing may be immediately after the information recording medium is initialized or formatted, immediately after a series of record data is recorded onto the information recording medium, and the like. In addition, the recording device records the altered record data into the spare area.

As a result, according to the recording apparatus of the present invention, it is possible to properly record the record data onto the information recording medium of the present invention described above, and it is possible to receive various benefit owned by the information recording medium.

Incidentally, in response to the various aspects of the information recording medium of the present invention described above, the recording apparatus of the present invention can adopt various aspects.

Alternatively, the defect management information may be obtained through the information recording medium or other communication channels. In this case, in place of generating or updating the defect management information, the defect management information generating device may be preferably able to obtain the defect management information through the information recording medium or the other communication channels.

Alternatively, if the information recording medium is an optical-type recording medium, the optical pickup is preferable as a device for directly recording the data or information onto the information recording medium. However, if the information recording medium is another type, such as a magnetic type, a magneto-optical type, and a type of using a change in a dielectric constant, it is possible to use a pickup, a head, or a probe or the like which is appropriate for the method of the information recording medium.

In one aspect of the recording apparatus of the present invention, the defect management information generating device generates or updates the defect management information, by further including first state information which indicates whether or not the alternative recording in the user data area or the alternative recording in the spare area is completed.

According to this aspect, the defect management information generating device generates the defect management information, by including the first state information in association with a pair of the evacuation source address (the alternative source address) and the evacuation destination address (the alternative destination address). Therefore, it is possible to unify a format required for the expression of a single defect list. For example, it is possible to sort by using the first state information as a key.

In another aspect of the recording apparatus of the present invention, the defect management information generating device generates or updates the defect management information, by further including second state information which indicates a record state of a first position at the evacuation source address corresponding to the first information or which indicates a record state of a second position at the alternative source address corresponding to the second information.

According to this aspect, the defect management information generating device generates the defect management information, by including the second state information in association with a pair of the evacuation source address (the alternative source address) and the evacuation destination address (the alternative destination address). Thus, by a recording/reproducing apparatus described later reading the second state information from the defect list, it is possible to directly access the desired address, such as a sector number, and it is possible to reduce the access time of accessing the desired record data, such as files.

In another aspect of the recording apparatus of the present invention, the recording apparatus is further provided with a first recording control device for controlling the recording device to record the generated or updated defect management information into the defect management area if the defect management information generating device generates or updates the defect management information.

According to this aspect, it is possible to reflect a defect in the user data area to the defect management information upon recording. More specifically, in performing recording processing of the record data into the user data area, the record data is recorded by each predetermined block, and verifying is performed at each time of the recording into one block. The “verifying” indicates an error detection operation of checking whether or not the record data has an error, or the like. The defect management information generating device preferably generates or updates the defect management information by using the result of the verifying. The defect management information may be stored in a memory device, for example. In this manner, it is possible to generate or update the defect management information in recording the record data, and it is possible to reflect a defect in the user data area to the defect management information upon recording.

The first recording control device controls the recording device to record the defect management information into the defect management area if the defect management information generating device generates or updates the defect management information. Timing when the first recording control device controls the recording device to record the defect management information into the defect management area, maybe in the middle of the generation of the defect management information by the defect management information generating device, or immediately after the generation of the defect management information is completed, or furthermore, sometime after the generation of the defect management information is completed.

By this, it is possible to reflect a defect in the user data area to the defect management information upon recording. Moreover, it is possible to record and hold the defect management information in the defect management area.

In another aspect of the recording apparatus of the present invention, the recording apparatus is further provided with a defect-management-information obtaining device for reading the defect management information from the defect management area of the information recording medium and for storing the read defect management information into a memory device, the defect management information generating device updating the defect management information stored in the memory device by the defect-management-information obtaining device if the recording device records the record data into the user data area, the first recording control device controlling the recording device to record the defect management information into the defect management area if the defect management information is updated.

According to this aspect, it is possible to reflect a defect newly formed on the user data area, to the defect management information already recorded in the defect management area.

More specifically, if the defect management information is already recorded in the defect management area on the write-once-type information recording medium loaded or mounted on the recording apparatus of the present invention, the defect-management-information obtaining device reads the defect management information from the defect management area, and stores the defect management information into the memory device, for example. Then, the defect management information generating device updates the defect management information that is stored in the memory device by the defect-management-information obtaining device, when the recording device records the record data into the user data area. Then, the first recording control device controls the recording device to record the defect management information into the defect management area when the defect management information is updated.

By this, it is possible to update the defect management information on the basis of the defect management information recorded and held in the defect management area in the past, and record and hold the updated defect management information in the defect management area. By this, it is possible to reflect a defect newly formed on the user data area to the defect management information, and hold this in the defect management area on the write-once-type information recording medium, for example.

Incidentally, when the information recording medium of the present invention is initialized or formatted, the defect management information generating device may generate the defect management information, with respect to the information recording medium on which the record data is unrecorded. In this case, it is preferable that the first recording control device can control the recording device to record the defect management information into the defect management area when the defect management information generating device generates the defect management information.

By this, it is possible to record and hold, in the defect management area, the defect management information generated when the write-once-type information recording medium is initialized or formatted. Incidentally, the “initialization or formatting” indicates an initial operation performed for the write-once-type information recording medium (e.g. initial error checking, elimination of all the data, and the like).

In addition, the above-described defect management information generating device may be provided with: a defect detecting device for detecting a defect in the user data area; and a spare area reserving device for reserving the spare area corresponding to the defect in the user data area.

In another aspect of the recording apparatus of the present invention, the information recording medium is further provided with a control information recording area to record therein information for controlling at least one of recording and reading into the user data area, the control information recording area including a definite defect management area to record therein defect management information of the user data area, and the recording apparatus is further provided with: a finalize-command device for giving a command for indicating to finalize the information recording medium; and a second recording control device for controlling the recording device to record the generated or updated defect management information into the definite defect management area if the finalize-command device gives the command for indicating to finalize.

According to this aspect, by recording the defect management information into the definite defect management area upon the finalizing, it is possible to ensure the compatibility between write-once-type information recording medium and the rewritable-type information recording medium. Here, the “finalizing” of the present invention includes the whole operation of arranging the address information and the control information or the like of the data recorded on the information recording medium to thereby finish it to a general purpose information recording medium. For example, by finalizing the information recording medium, it is possible to reproduce the record data on the write-once-type information recording medium, by a reproducing apparatus of a reproduce-only type or various reproducing apparatuses compatible with other information recording media.

More specifically, for example, if a user wants to reproduce the record data recorded on the write-once-type information recording medium by using a reproducing apparatus for a rewritable-type information recording medium or a reproducing apparatus for a reproduce-only type information recording medium, the user inputs an instruction for indicating to finalize the write-once-type information recording medium, to the recording apparatus of the present invention. In response to this, the finalize-command device gives a command for indicating to finalize the information recording medium that is currently loaded or mounted on the recording apparatus. Moreover, if the recording apparatus judges that the user data area is full of the record data and it is not preferable to record the record data anymore, the recording apparatus may automatically finalize it. If such construction is adopted, the finalize-command device gives a command for indicating to finalize the information recording medium, in accordance with the judgment of the recording apparatus.

Then, the second recording control device controls the recording device to record the defect management information stored in the memory device, into the definite defect management area if the finalize-command device gives the command for indicating to finalize. Then, the recording device records the defect management information stored in the memory device, into the definite defect management area on the write-once-type information recording medium. As a result, the defect management information is recorded in the definite defect management area on the write-once-type information recording medium after the finalizing.

By this, it is possible to ensure the compatibility between write-once-type information recording medium and the rewritable-type information recording medium. In most cases, the finalizing is performed if the user thinks that the recording of the record data is completed. Thus, by using the opportunity of the finalizing to record the defect management information into the definite defect management area, it is possible to establish the compatibility between write-once-type information recording medium and the rewritable-type information recording medium in timing which matches the user's will.

Incidentally, the finalize-command device may give the command for indicating to finalize the information recording medium, in accordance with an eject command. Even this makes it possible to establish the compatibility between write-once-type information recording medium and the rewritable-type information recording medium in timing which matches the user's will.

Alternatively, the recording device may record the defect management information into the definite defect management area, a plurality of times repeatedly. In addition, the recording device may record the defect management information into a plurality of definite defect management areas which exist at a plurality of points on the write-once-type information recording medium, redundantly.

The above object of the present invention can be also achieved by a recording method of recording record data onto an information recording medium provided with: (i) a user data area to record therein the record data; (ii) a spare area to alter thereto one portion of the user data area, along with defect management in the user data area; and (iii) a defect management area to record therein defect management information which includes first information and second information, the first information indicating a correspondence relationship between an evacuation source address in the user data area and an evacuation destination address in the spare area, along with alternative recording in the user data area based on the defect management, the second information indicating a correspondence relationship between an alternative source address in the spare area and an alternative destination address in the spare area, along with alternative recording in the spare area based on the defect management, the recording method provided with: a defect management information generating process of generating or updating the defect management information; and a control process of controlling a recording device to record at least one of the record data and the generated or updated defect management information.

According to the recording method of the present invention, as in the recording apparatus of the present invention described above, it is possible to properly record the record data onto the information recording medium of the present invention (including its various aspects).

Incidentally, in response to the various aspects of the recording apparatus (or the information recording medium) of the present invention described above, the recording method of the present invention can adopt various aspects.

(Reproducing Apparatus and Method)

The above object of the present invention can be also achieved by a reproducing apparatus for reproducing record data recorded on the above-described information recording medium of the present invention (including its various aspects), the reproducing apparatus provided with: a memory device; a reading device for reading the defect management information recorded in the defect management area and storing the read defect management information into the memory device; and a reproducing device for reproducing the record data recorded in the user data area or the record data recorded in the spare area, on the basis of the defect management information stored in the memory device.

According to the reproducing apparatus of the present invention, it is possible to properly reproduce the record data recorded on the information recording medium of the present invention described above, by using the reading device, which includes an optical pickup, a controller for controlling the optical pickup, and the like, and the reproducing device, which includes a decoder for converting the image data to an image signal displayable on a display, or the like, for example.

More specifically, the reading device reads the defect management information recorded in the defect management area. The defect management information may be stored in the memory device, such as a memory, for example. The record data is recorded in the user data area on the information recording medium, by the alternative recording operation based on the defect management, upon recording. Thus, in order to reproduce the record data recorded in this manner, it is necessary to know the alternative destination address. The reproducing device recognizes the alternative source address in the user data area on the basis of the defect management information stored in the memory device, and recognizes the alternative destination address at which the record data is recorded away from the alternative source address, to thereby reproduce the record data recorded in the user data area or the record data recorded in the spare area.

As a result, according to the reproducing apparatus of the present invention, it is possible to properly reproduce the record data on the information recording medium of the present invention described above.

Incidentally, in response to the various aspects of the recording apparatus of the present invention described above, the reproducing apparatus of the present invention can adopt various aspects.

The above object of the present invention can be also achieved by a reproducing method of reproducing record data recorded on the above-described information recording medium of the present invention (including its various aspects), the reproducing method provided with: a reading process of reading the defect management information recorded in the defect management area; and a reproducing process of reproducing the record data recorded in the user data area or the record data recorded in the spare area, on the basis of the read defect management information.

According to the reproducing method of the present invention, as in the reproducing apparatus of the present invention described above, it is possible to properly reproduce the record data recorded on the information recording medium of the present invention (including its various aspects).

Incidentally, in response to the various aspects of the reproducing apparatus of the present invention described above, the reproducing method of the present invention can adopt various aspects.

(Computer Program Product)

The above object of the present invention can be also achieved by a first computer program product in a computer-readable medium for tangibly embodying a program of instructions executable by a computer in the above-described recording apparatus of the present invention (including its various aspects) to make the computer function as at least one portion of a defect management information generating device and a recording device.

According to the first computer program product of the present invention, the recording apparatus of the present invention described above can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the first computer program product may be provided with computer readable codes (or computer readable commands) to make the computer to function as the recording apparatus of the present invention described above.

Incidentally, in response to the various aspects of the information recording medium of the present invention described above, the first computer program product of the present invention can adopt various aspects.

The above object of the present invention can be also achieved by a second computer program product in a computer-readable medium for tangibly embodying a program of instructions executable by a computer in the above-described reproducing apparatus of the present invention (including its various aspects) to make the computer function as at least one portion of a reading device and a reproducing device.

According to the second computer program product of the present invention, the reproducing apparatus of the present invention described above can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the second computer program product may be provided with computer readable codes (or computer readable commands) to make the computer to function as the reproducing apparatus of the present invention described above.

Incidentally, in response to the various aspects of the information recording medium of the present invention described above, the second computer program product of the present invention can adopt various aspects.

(Data Structure Including Control Signal)

The above object of the present invention can be also achieved by a data structure including a control signal, provided with: a user data area to record therein record data; a spare area to alter thereto one portion of the user data area, along with defect management in the user data area; and a defect management area to record therein defect management information which includes first information and second information, the first information indicating a correspondence relationship between an evacuation source address in the user data area and an evacuation destination address in the spare area, along with alternative recording in the user data area based on the defect management, the second information indicating a correspondence relationship between an alternative source address in the spare area and an alternative destination address in the spare area, along with alternative recording in the spare area based on the defect management.

According to the data structure including a control signal, it has the same structure as that of the information recording medium of the present invention described above. Thus, even if there is a defect at the address of the desired ECC block in the RMW processing and the record data cannot be read, it is possible to refer to the defect management information and go back in time and obtain the history of the alternative recording. Thus, it is possible to reproduce again the record data which is recorded at the position of the evacuation source address (or the alternative source address) on the basis of the defect management (or the alternative recording in the spare area).

Incidentally, in response to the various aspects of the information recording medium of the present invention described above, the data structure including a control signal of the present invention can adopt various aspects.

The nature, utility, and further features of this invention will be more clearly apparent from the following detailed description with reference to preferred embodiments of the invention when read in conjunction with the accompanying drawings briefly described below.

As explained above, according to the information recording medium of the present invention, it is provided with: the user data area; the spare area; and the defect management area in which the defect management information, which includes the first information and the second information, is recorded. For example, even if there is a defect at the address of the desired ECC block in the RMW processing and the record data cannot be read, it is possible to refer to the defect management information and go back in time and obtain the history of the alternative recording. Thus, it is possible to reproduce again the record data which is recorded at the position of the evacuation source address (or the alternative source address) on the basis of the defect management (or the alternative recording in the spare area).

Moreover, according to the recording apparatus of the present invention, it is provided with the defect management information generating device and the recording device. According to the recording method of the present invention, it is provided with the defect management information generating process and the recording process. Therefore, it is possible to properly record the record data onto the information recording medium of the present invention. Moreover, according to the reproducing apparatus of the present invention, it is provided with the reading device and the reproducing device. According to the recording method of the present invention, it is provided with the reading process and the reproducing process. Therefore, it is possible to properly read and reproduce the record data from the information recording medium of the present invention.

### BRIEF DESCRIPTION OF THE DRAWINGS

FIG. 1 is an explanatory diagram showing a first embodiment of an information recording medium in the present invention;

FIG. 2 is an explanatory diagram showing the content of defect management information in the information recording medium in the first embodiment of the present invention;

FIG. 3 is an explanatory diagram showing one example of a defect list in the information recording medium in the first embodiment of the present invention;

FIG. 4 is an explanatory diagram showing one example of the record content of a temporary defect management area in the information recording medium in the first embodiment of the present invention;

FIG. 5 is an explanatory diagram showing one example of the record content of a definite defect management area in the information recording medium in the first embodiment of the present invention;

FIG. 6A and FIG. 6B are explanatory diagrams showing one specific example of the defect list (FIG. 6A) and another example (FIG. 6B) in the information recording medium in the first embodiment of the present invention;

FIG. 7 is a block diagram showing a recording/reproducing apparatus, which is a first embodiment of a recording apparatus and a reproducing apparatus of the present invention;

FIG. 8 is a block diagram showing a disc drive of the recording/reproducing apparatus in the first embodiment of the present invention;

FIG. 9 is a block diagram showing a backend of the recording/reproducing apparatus in the first embodiment of the present invention;

FIG. 10 is a flowchart showing an initial setting operation of the recording/reproducing apparatus in the first embodiment of the present invention;

FIG. 11 is a flowchart showing a recording operation and the like of the recording/reproducing apparatus in the first embodiment of the present invention;

FIG. 12 is a flowchart showing a finalize operation of the recording/reproducing apparatus in the first embodiment of the present invention;

FIG. 13 is a flowchart showing a reproduction operation of the recording/reproducing apparatus in the first embodiment of the present invention;

FIG. 14 is a conceptual diagram of a data structure, schematically showing recording areas by an ECC block (a so-called cluster) unit in first and second phases of the recording operation in which defect management is performed by a recording/reproducing apparatus associated with the information recording/reproducing apparatus in the first embodiment of the present invention;

FIG. 15 is a conceptual diagram of a data structure, schematically showing the recording area and the defect list by the ECC block unit in a third phase of the recording operation in which the defect management is performed by the recording/reproducing apparatus associated with the information recording/reproducing apparatus in the first embodiment of the present invention;

FIG. 16 is a conceptual diagram of a data structure, schematically showing the recording area and the defect list by the ECC block unit in a fourth phase of the recording operation in which the defect management is performed by the recording/reproducing apparatus associated with the information recording/reproducing apparatus in the first embodiment of the present invention;

FIG. 17 is a conceptual diagram of a data structure, schematically showing the recording area and the defect list by the ECC block unit in a fifth phase of the recording operation in which the defect management is performed by the recording/reproducing apparatus associated with the information recording/reproducing apparatus in the first embodiment of the present invention;

FIG. 18 is a conceptual diagram, schematically showing the recording area and the defect list by the ECC block unit in the recording operation in which the defect management is performed by a recording/reproducing apparatus associated with a comparison example;

FIG. 19 is a table schematically showing a data structure which is one specific example of the defect list of the defect management information in an information recording medium in a second embodiment of the present invention;

FIG. 20 is a conceptual diagram of a data structure, schematically showing the recording area and the defect list by the ECC block unit in the recording operation in which the defect management is performed by the recording/reproducing apparatus associated with the information recording/reproducing apparatus in the second embodiment of the present invention; and

FIG. 21 is an explanatory diagram showing another embodiment of the information recording medium in the present invention.

### DETAILED DESCRIPTION OF THE PREFERRED EMBODIMENTS

The embodiments of the present invention will be explained with reference to the drawings hereinafter. In the embodiments below, the information recording medium of the present invention is applied to an optical disc, and the recording apparatus and the reproducing apparatus of the present invention are applied to a recording/reproducing apparatus for the optical disc.

### First Embodiment of Information Recording Medium

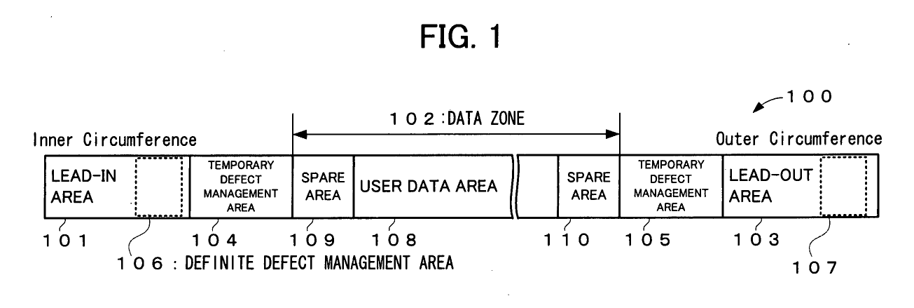

With reference to FIG. 1 to FIG. 6, the first embodiment of the information recording medium of the present invention will be explained.

At first, the record structure of the optical disc in the first embodiment of the present invention, and information and data recorded on the optical disc will be explained. FIG. 1 shows the record structure of the optical disc, which is the first embodiment of the present invention. Incidentally, the left side of FIG. 1 is the inner circumferential side of an optical disc 100, and the right side of FIG. 1 is the outer circumferential side of the optical disc 100.

As shown in FIG. 1, there are a lead-in area 101 on the inner circumferential side, a data zone 102 on the outer circumferential side of the lead-in area 101, and a lead-out area 103 on the outer circumferential side of the data zone 102, on a recording surface of the optical disc 100. In the data zone 102, a temporary defect management area 104 is placed on the disc inner circumferential side, and a temporary defect management area 105 is placed on the disc outer circumferential side. Incidentally, there may be provided one temporary defect management area. Alternatively, there may be provided two, three or more, i.e., a plurality of temporary defect management areas.

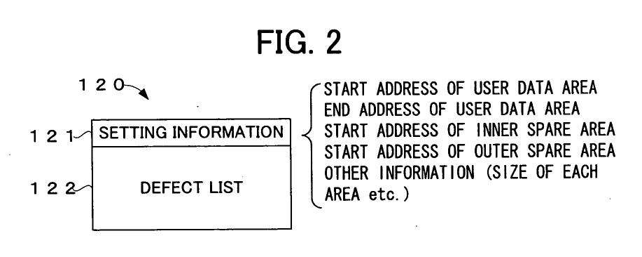

In both the lead-in area 101 and the lead-out area 103, control information and management information and the like for controlling and managing the recording or reading of the information or data onto the optical disc 100 are recorded. The lead-in area 101 is provided with a definite defect management area 106. The lead-out area 103 is provided with a definite defect management area 107. In both the defect management areas 106 and 107, defect management information 120 (refer to FIG. 2) is recorded.

Moreover, in the data zone 102, the record data is recorded, such as image data, audio data, and content data. There are provided: a user data area 108 in the middle of the data zone 102; a spare area 109 between the user data area 108 and the temporary defect management area 104; and a spare area 110 between the user data area 108 and the temporary defect management area 105. Incidentally, the spare area 110 may not be provided. In this case, the temporary defect management area 105 is also not provided. The user data area 108 is a main area to record the “record data”. The spare areas 109 and 110 are intended to evacuate the record data from a defect in the user data area 108. Namely, if there is a defect in the user data area 108, the record data to be recorded or already recorded at the position of the defect, i.e. evacuation data, is alternatively recorded into the spare area 109 or 110. Incidentally, the record data and the above-described control information cannot be always clearly distinguished depending on their content. However, the control information is mainly used directly for the operation control of a drive apparatus. The record data is mainly only the object of the recording and reading on the drive apparatus, and is mainly used in the data reproduction processing or program execution processing of a backend or a host computer.

In both the temporary defect management areas 104 and 105, the defect management information 120 is temporarily recorded. Incidentally, the defect management information 120 is also recorded in both the definite defect management areas 106 and 107. The differences between the definite defect management areas 106 and 107 and the temporary defect management areas 104 and 105 will be explained later.

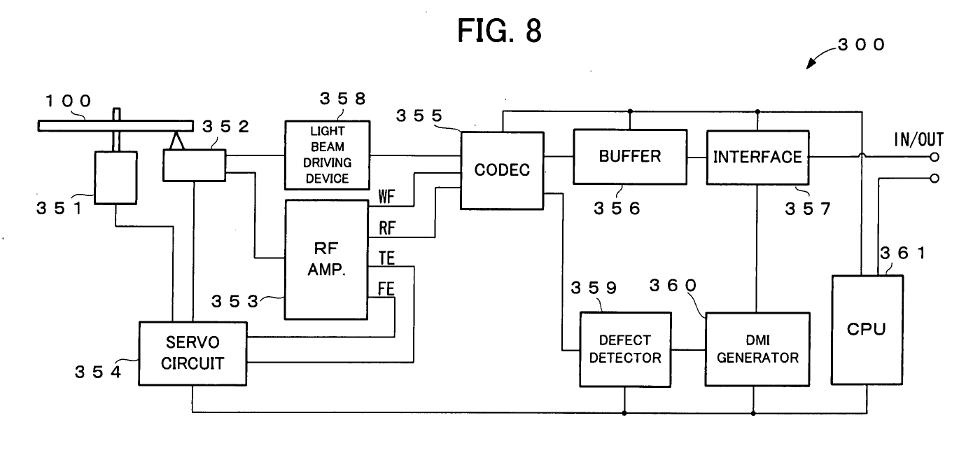

Next, with reference to FIG. 2, the defect management information 120 will be explained. The defect management information 120 is used for the defect management performed by a recording/reproducing apparatus 200 (refer to FIG. 8). The recording/reproducing apparatus 200 performs LOW (Logical OverWriting), in addition to or in place of the defect management, when recording the record data onto the optical disc 100 or when reproducing the record data from the optical disc 100. In the first embodiment, the defect management is mainly as follows. If there is a defect, such as scratches, dusts, or deterioration, on the user data area 108 on the optical disc 100, the record data is recorded away from the position of the defect. At the same time, the evacuation data is recorded into the spare area 109 or 110. Moreover, the following operations are also performed as a part of the defect management: an operation of recognizing the position of a defect in reproducing the record data recorded in the user data area 108, and an operation of reading from the spare area 109 or 110 the record data to be originally recorded or already recorded at the position of the defect. In order to perform such defect management, the recording/reproducing apparatus 200 needs to recognize the position of a defect in the user data area 108. The defect management information 120 is mainly used for the recording/reproducing apparatus 200 recognizing the position of a defect.

FIG. 2 shows the content of the defect management information 120. As shown in FIG. 2, setting information 121 and a defect list (DFL) 122 are included in the defect management information 120.

The setting information 121 includes: the start address of the user data area 108; the end address of the user data area 108; the start address of the inner spare area 109; the start address of the outer spare area 110; and other information (e.g. the sizes of the areas, and other information about the disc, and the like), as shown in FIG. 2. Incidentally, the structural order of the setting information and the defect list may be opposite.

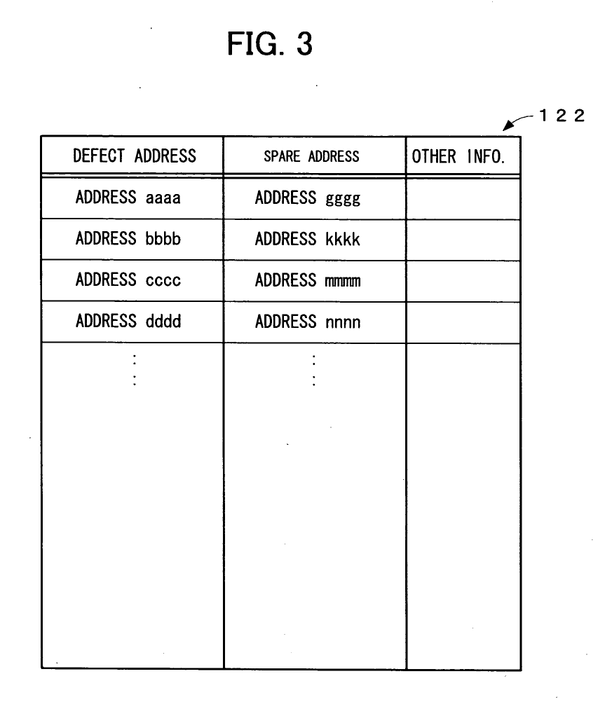

FIG. 3 shows the content of the defect list 122. As shown in FIG. 3, on the defect list 122, there are recorded an address for indicating the position of a defect in the user data area 108 (which is hereinafter referred to as a “defect address”), an address for indicating the recording position in the spare area 109 or 110 of the evacuation data (which is hereinafter referred to as a “spare address”); and other information. Namely, the defect address may indicate mainly one example of the “alternative source address” of the present invention, in addition to or in place of the “evacuation source address” of the present invention. The spare address may indicate mainly one example of the “alternative destination address” of the present invention, in addition to or in place of the “evacuation destination address” of the present invention. If there are a plurality of defects in the user data area 108, a plurality of defect addresses and spare areas corresponding to the defects are recorded on the defect list 122.

Particularly, in the first embodiment, as the other information, there are appended first and second state information for indicating whether alternative recording is completed in association with a pair of one defect address and one spare address (which is hereinafter referred to as a “defect list entry”). Incidentally, the first and second state information will be described in detail later.

Incidentally, the defect management can be performed not only for the user data area 108 of the optical disc 100, but also for the whole recording surface of the optical disc 100.

Moreover, the defect list is recorded in a particular area of the recording medium. For example, in a rewritable optical disc using a blue laser, the defect list is recorded into a predetermined area reserved in the lead-in area or lead-out area on the disc (which is hereinafter referred to as a “defect management area”). Then, the record data to be originally recorded at the position of a defect is also recorded in the particular area of the recording medium.

As described above, the defect list is updated at each time of the additional (or postscript) recording and rewriting of the record data. Every time the defect list is updated by the additional recording and rewriting of the record data, the defect list is additionally recorded (or written once) and rewritten in proper timing, into the defect management area of the recording medium which is the object of the additional recording and rewriting. In addition, the record data to be originally recorded at the position of a defect is also additionally recorded (or written once) and rewritten into the particular area of the recording medium. More specifically, in the case of the write-once-type recording medium, e.g., the write-once-type optical disc, every time the defect list is updated, for example, the updated defect list is additionally recorded or written once in proper timing, into a new unrecorded area of the information recording medium.

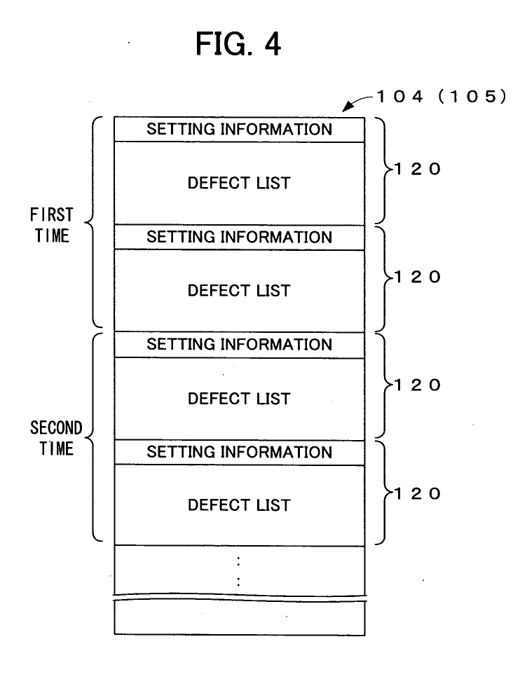

Next, with reference to FIG. 4, the aspect of the recording of the defect management information 120 will be explained. The temporary defect management areas 104 and 105 and the definite defect management areas 106 and 107 of the optical disc 100 are all intended to record therein the defect management information 120. However, the temporary defect management areas 104 and 105 and the definite defect management areas 106 and 107 differ in their positions, size, and purpose of use. The differences of the both areas will be specifically explained below.

FIG. 4 shows one example of the state that the defect management information 120 is recorded in the temporary defect management area 104 or 105. The temporary defect management areas 104 and 105 are intended to temporarily record therein the defect management information 120 until the optical disc 100 is finalized. The defect management information 120 is necessary for the defect management, and the presence or absence, and position of a defect are different in the each individual optical disc. Thus, it is necessary to record and hold the defect management information on the individual optical disc. In the first embodiment, at a stage before the finalizing, the defect management information 120 is recorded and held in the temporary defect management area 104 or 105 on the optical disc 100.

Moreover, in the first embodiment, as shown in FIG. 4, the defect management information 120 is preferably recorded repeatedly twice in the temporary defect management area 104 or 105 (incidentally, FIG. 4 shows the state that the repetitive recording of the defect management information 120 is performed twice, so that four defect management information 120 in total are illustrated). By this, it is possible to certainly record and reproduce the defect management information 120. Even if the recording is not performed twice, for example, if the recording is performed once, or three times or more, it is possible to properly record and reproduce the defect management information 120 and the evacuation data.

In some cases, the defect management information 120 may be updated several times until the optical disc 100 is finalized. For example, if dirt is attached on the optical disc 100 between the first recording and the second recording (e.g. the additional or postscript recording), the defect (or dirt) is detected upon the second recording. On the basis of the detection, the defect list 122 is updated. If the defect list 122 is updated, the defect management information 120 including the updated defect list 122 is additionally recorded or written once into the temporary defect management area 104 or 105. Since the optical disc 100 is a write-once-type recording medium, it is impossible to record the updated defect management information 120 over the existing defect management information 120. Thus, as shown in FIG. 4, the updated defect management information 120 is recorded in series after the existing defect management information 120.

In order to realize the repetitive and series recording of the defect management information 120 as described above, the temporary defect management areas 104 and 105 are larger than the definite defect management areas 106 and 107.

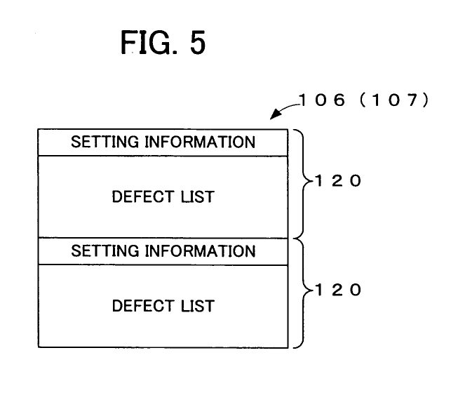

On the other hand, FIG. 5 shows one example of the state that the defect management information 120 is recorded in the definite defect management area 106 or 107. The definite defect management areas 106 and 107 are intended to definitely record therein the defect management information 120 when the optical disc 100 is finalized. Namely, at a stage before the finalizing, the definite defect management areas 106 and 107 are unrecorded or blank. When the optical disc 100 is finalized, the defect management information 120 is recorded into the definite defect management areas 106 and 107, and after that, the recorded state continues.

In the first embodiment, as shown in FIG. 5, the defect management information 120 is preferably recorded repeatedly twice in the definite defect management area 106 or 107. By this, it is possible to certainly record and reproduce the defect management information 120. Even if the recording is not performed twice, for example, if the recording is performed once, or three times or more, it is possible to properly record and reproduce the defect management information 120.

According to the optical disc 100 in the first embodiment, the temporary defect management area 104 is placed between the lead-in area 101 and the data zone 102, and the temporary defect management area 105 is placed between the data zone 102 and the lead-out area 103. Thus, it is possible to provide compatibility between the write-once-type optical disc 100 and a general rewritable optical disc. In order to realize the compatibility with a general rewritable optical disc, the optical disc 100 needs to have the lead-in area, the data zone, and the lead-out area. It also needs to maintain a basic recording structure, such as the order, arrangement, and size (extent) of the areas. Although it is provided with the temporary defect management areas 104 and 105, the optical disc 100 maintains such a basic recording structure, which allows the compatibility. Namely, if the temporary defect management area 104 is placed in the lead-in area 101, because the temporary defect management area 104 is relatively large as described above, there is no choice but to extend the size of the lead-in area 101, which is unfavorable. In the first embodiment, however, the above disadvantage does not occur because the temporary defect management area 104 is placed out of the lead-in area 101. Moreover, if the temporary defect management area 104 is placed in the data zone 102, the defect management information 120 having properties of the control information is included in the data zone 102, which is an area in which the record data is supposed to be recorded. This causes the disadvantage that the control information and the record data, which is information having properties different from those of the control information, are mixed in the data zone 102. In the first embodiment, however, the above disadvantage does not occur because the temporary defect management area 104 is placed out of the data zone 102. The same is true for the defect management area 105.

Incidentally, the start address and end address of the user data area 108, and the start addresses of the spare areas 109 and 110 (or the size of the user data area 108, and the spare areas 109 and 110, and the like) are included in the setting information 121 in the defect management information 120 (refer to FIG. 2). This setting information 121 can be set by the recording/reproducing apparatus 200. Namely, it is allowed to change the start address and end address of the user data area 108, and the sizes of the spare areas 109 and 110, if they are clearly shown as the setting information 121. Even if they are changed, it is possible to maintain the compatibility with a general rewritable-type recording medium. Therefore, it is possible to reserve or ensure a space between the lead-in area 101 and the data zone 102 by shifting the start address of the user data area 108 backward (to the outer circumferential side). It is also possible to place the temporary defect management area 104 in the space. Depending on how to set the start address of the user data area 108, the relatively wider (large-sized) temporary defect management area 104 can be reserved or ensured. The same is true for the temporary defect management area 105.

According to the optical disc 100 in the first embodiment, the definite defect management areas 106 and 107 are placed in the lead-in area 101 and the lead-out area 103, respectively. This allows the compatibility between the write-once-type optical disc 100 and a general rewritable optical disc. Namely, a general rewritable optical disc has areas to record therein the defect management information, in both the lead-in area and the lead-out area. The optical disc 100 also has the definite defect management areas 106 and 107 placed in the lead-in area 101 and the lead-out area 103, respectively. At this point, their recording structures coincide. Therefore, it is possible to ensure the compatibility between the write-once-type optical disc 100 and a general rewritable optical disc.

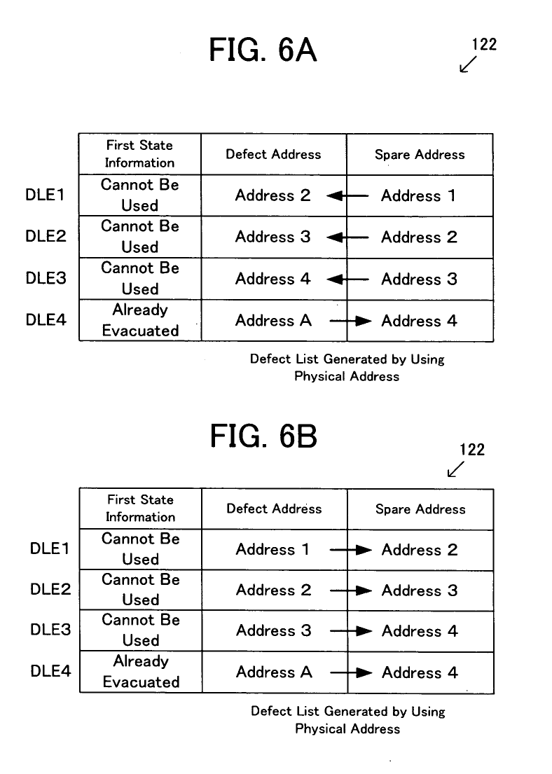

Next, with reference to FIG. 6A and FIG. 6B, the defect list which is the defect management information associated with the information recording medium in the first embodiment of the present invention will be explained. FIG. 6A is a table conceptually showing a data structure which is one specific example of the defect list of the defect management information associated with the information recording medium of the present invention. FIG. 6B is a table conceptually showing a data structure which is another specific example of the defect list.

As shown in FIG. 6A, in one specific example of the defect list, a group of one “defect address” expressed by a physical address, one “spare address” also expressed by a physical address, and the “first state information” is appended, wherein the physical address indicates absolute position information in the recording area of the optical disc. Namely, the defect list entries (DLE 1 to DLE 4) are appended. Specially a direction of an arrow in the defect list as shown in FIG. 6A (FIG. 6B), indicates an order of accessing by the recording/reproducing apparatus 200 in the embodiment of the present invention.

The “defect address” indicates the evacuation source address in the user data area based on the defect management, or the alternative destination address in the spare area based on the alternative recording in the spare area.

The “spare address” indicates the evacuation destination address in the spare area based on the defect management, or the alternative source address in the spare area based on the alternative recording in the spare area.

If the “first state information” indicates “already evacuated”, the defect list entry may show a group of the evacuation source address in the user data area based on the defect management and the evacuation destination address in the spare area. On the other hand, if the “first state information” indicates “cannot be used”, the defect list entry may show a group of the alternative destination address in the spare area and the alternative source address in the spare area on the basis of the alternative recording in the spare area.

Therefore, it is possible to unify a format required for the expression of a single defect list. For example, it is possible to sort by using the “first state information” as a key. More specifically, it is possible to sort by the alternative destination address or the alternative source address in the spare area based on the alternative recording in the spare area. As described above, it is possible to facilitate handling, such as the updating, rearrangement or sorting, and generation of the defect list.

More specifically, the defect list will be explained from the lower side to the upper side. The defect list entry DLE4 is a group of an evacuation source address A in the user data area, an evacuation destination address 4 in the spare area, and first state information for indicating “already evacuated”. The defect list entry DLE3 is a group of an alternative destination address 4 in the spare area, an alternative source address 3 in the spare area, and first state information for indicating “cannot be used”. The defect list entry DLE2 is a group of an alternative destination address 3 in the spare area, an alternative source address 2 in the spare area, and first state information for indicating “cannot be used”. The defect list entry DLE1 is a group of an alternative destination address 2 in the spare area, an alternative source address 1 in the spare area, and first state information for indicating “cannot be used”.

As shown in FIG. 6B, in another specific example of the defect list, as in the one specific example, a group of one “defect address”, one “spare address”, and the “first state information” is appended. Namely, the defect list entries (DLE1 to DLE 4) are appended.

The “defect address” indicates the evacuation source address in the user data area based on the defect management, or the alternative source address in the spare area based on the alternative recording in the spare area, which is different from the one specific example as shown in FIG. 6A.

The “spare address” indicates the evacuation destination address in the user data area based on the defect management, or the alternative destination address in the spare area based on the alternative recording in the spare area, which is also different from the one specific example as shown in FIG. 6A.

The “first state information” indicates whether the defect list entry is “already evacuated” or “cannot be used”, as in the one specific example.

More specifically, the defect list will be explained from the lower side to the upper side. The defect list entry DLE4 is a group of the evacuation source address A in the user data area, the evacuation destination address 4 in the spare area, and the first state information for indicating “already evacuated”, as in the one specific example. The defect list entry DLE3 is a group of the alternative source address 3 in the spare area, the alternative destination address 4 in the spare area, and the first state information for indicating “cannot be used”. The defect list entry DLE2 is a group of the alternative source address 2 in the spare area, the alternative destination address 3 in the spare area, and the first state information for indicating “cannot be used”. The defect list entry DLE1 is a group of the alternative source address 1 in the spare area, the alternative destination address 2 in the spare area, and the first state information for indicating “cannot be used”.

Incidentally, in the above-described one specific example and another specific example of the defect list, the data amount of the first state information may be 1 bit, for example. Specifically, if the first state information is “0”, the defect list entry may mean that it is “already evacuated”. On the other hand, if the first state information is “1”, the defect list entry may mean that it “cannot be used”.

Moreover, in the above-described one specific example and another specific example of the defect list, the defect address and the spare address are expressed by the physical address for indicating the absolute position information. However, the defect address and the spare address may be expressed by an offset address or the like, for example, which indicates relative position information. By this, it is possible to reduce the data amount of the defect list.

### First Embodiment of Information Recording/Reproducing Apparatus

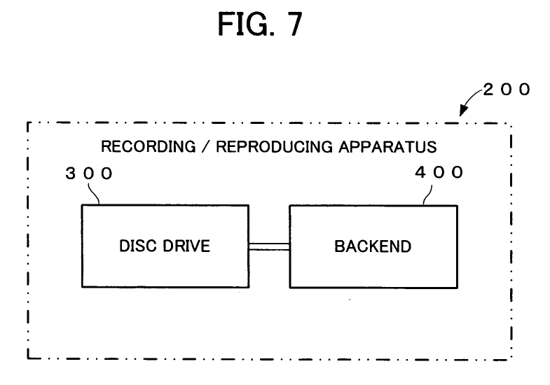

Next, with reference to FIG. 7 to FIG. 17, the structure and operation of the information recording/reproducing apparatus in the first embodiment of the present invention will be described in detail.

At first, with reference to FIG. 7 to FIG. 9, the structure of the recording/reproducing apparatus as being the embodiment of the present invention will be explained. FIG. 7 shows the recording/reproducing apparatus 200, which is the embodiment of the present invention. The recording/reproducing apparatus 200 has both a function of recording the record data onto the optical disc 100 and a function of reproducing the record data recorded on the optical disc 100.

The recording/reproducing apparatus 200 is provided with: a disc drive 300; and a backend 400.

FIG. 8 shows the inner structure of the disc drive 300. The disc drive 300 records information onto the optical disc 100 and reads the information recorded on the optical disc 100.

As shown in FIG. 8, the disc drive 300 is provided with: a spindle motor 351; an optical pickup 352; a Radio Frequency (RF) amplifier 353; and a servo circuit 354.

The spindle motor 351 is a motor for rotating the optical disc 100.

The optical pickup 352 records the record data or the like onto the recording surface of the optical disc 100 by irradiating the recording surface with a light beam, and reads the record data or the like recorded on the recording surface by receiving reflected light of the light beam. The optical pickup 352 outputs a RF signal corresponding to the reflected light of the light beam.

The RF amplifier 353 amplifies the RF signal outputted from the optical pickup 352, and outputs it to a CODEC (i.e., a device mainly having functions of an encoder and a modulator upon recording as well as a demodulator and a decoder upon reading) 355. Moreover, the RF amplifier 353 generates, from the RF signal, a wobble frequency signal WF, a track error signal TE, and a focus error signal FE, and outputs them.

The servo circuit 354 is a servo control circuit for controlling the driving of the optical pickup 352 and the spindle motor 351 on the basis of the track error signal TE, the focus error signal FE, and other servo control signals.

Moreover, as shown in FIG. 8, the disc drive 300 is provided with: the CODEC 355; a buffer 356; an interface 357; and a light beam driving device 358.

The CODEC 355 is a circuit, provided with: a function of performing an error correction for the record data upon reading; and a function of appending an error correction code or mark to the record data upon recording so as to demodulate and decode the record data. Specifically, the CODEC 355 demodulates and decodes the RF signal outputted from the RF amplifier 353 upon reading, performs an error correction for the decoded RF signal, and then outputs this to the buffer 356. Moreover, if the error correction is impossible as a result of performing the error correction for the decoded RF signal, the CODEC 355 generates an error-correction-impossible signal for indicating that, and outputs this signal to a defect detector 359. Upon recording, the CODEC 355 appends the error correction code to the record data outputted from the buffer 356, demodulates and decodes this data to have a code suited to the optical characteristics or the like of the optical disc 100, and then outputs the decoded record data to the light beam driving device 358.

The buffer 356 is a memory circuit for storing the record data temporarily.

The interface 357 is a circuit for controlling the input/output or communication of the record data or the like between the disc drive 300 and the backend 400. Specifically, upon reproducing, the interface 357 responds a request command from the backend 400, and outputs the record data outputted from the buffer 356 (i.e. the record data read from the optical disc 100) to the backend 400. Upon recording, the interface 357 receives the record data which is inputted from the backend 400 to the disc drive 300, and outputs this data to the buffer 356. Moreover, the interface 357 responds a request command from the backend 400, and outputs all or part of the defect lists maintained in a generator 360 for generating Defect Management Information (DMI generator 360) to the backend 400.

Upon recording, the light beam driving device 358 generates a light beam driving signal corresponding to the record data outputted from the CODEC 355, and outputs this signal to the optical pickup 352. The optical pickup 352 modulates a light beam on the basis of the light beam driving signal, and irradiates the recording surface of the optical disc 100 with it. This causes the recording of the record data or the like on the recording surface.

Moreover, as shown in FIG. 8, the disc drive 300 is provided with: the defect detector 359; and the DMI generator 360.

The defect detector 359 is a circuit for detecting a defect on the optical disc 100. The defect detector 359 generates a defect detection signal for indicating the presence or absence of a defect, and outputs this signal. The defect detector 359 detects a defect on the basis of the result of the error correction of the record data upon reading information (upon verifying or reproducing). As described above, if the error correction is impossible as a result of performing the error correction for the decoded RF signal, the CODEC 355 generates the error correction impossible signal for indicating the fact, and outputs this signal to the defect detector 359. The defect detector 359 outputs the defect detection signal for indicating the presence of a defect when receiving this error correction impossible signal.

The DMI generator 360 is a circuit for generating or updating the defect management information 120 on the basis of the defect detection signal outputted from the defect detector 359. The defect management information 120 is rewritably stored into a memory circuit placed in the DMI generator 360. The DMI generator 360 responds to a request command from the backend 400 and outputs the defect management information 120 to the backend 400 through the interface 357.

As shown in FIG. 8, the disc drive 300 is equipped with a Central Processing Unit (CPU) 361. The CPU 361 controls the disc drive 300 as a whole, and controls the exchange of information among the elements in the disc drive 300 described above. The CPU 361 also controls the recording operation and reading operation of the record data and the defect management information 120. The CPU 361 responds to a control command or a request commend transmitted from the backend 400 and controls the exchange of data between the disc drive 300 and the backend 400.

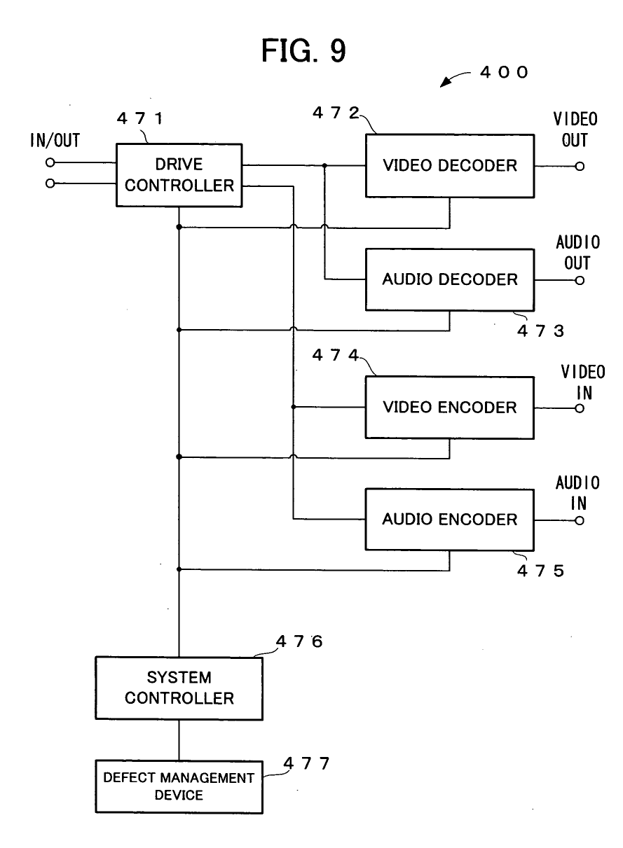

Next, FIG. 9 shows the inner structure of the backend 400. The backend 400 is an apparatus for performing reproduction processing with respect to the record data read by the disc drive 300 from the optical disc 100, receiving the record data supplied from the outside in order to record it onto the optical disc 100, compressing and encoding this record data, and transmitting it to the disc drive 300.

The backend 400 is provided with: a drive controller 471; a video decoder 472; an audio decoder 473; a video encoder 474; an audio encoder 475; a system controller 476; and a defect management device 477.

The drive controller 471 is a circuit for controlling the reading processing and recording processing of the disc drive 300. The backend 400 and the disc drive 300 cooperate and perform an operation of reading the record data from the optical disc 100 and reproducing it and an operation of receiving the record data from the outside and recording it onto the optical disc 100. The drive controller 471 realizes the cooperation of the backend 400 and the disc drive 300 by controlling the reading processing and recording processing of the disc drive 300. Specifically, the drive controller 471 outputs to the disc drive 300 request commands about reading, recording, outputting the record data from the buffer 356, outputting the defect management information 120 from the DMI generator 360, and so on. The drive controller 471 also performs input/output control of controlling the input and output of the record data, the defect management information 120, and other various information.

The video decoder 472 and the audio decoder 473 are circuits for decoding the record data which is read from the optical disc 100 by the disc drive 300 and which is supplied through the drive controller 471, and converting the record data to be reproducible with a display, a speaker, or the like.

The video encoder 474 and the audio encoder 475 are circuit for receiving a video signal, an audio signal, or the like inputted from the outside for the purpose of recording them on the optical disc 100, compressing and encoding them by Moving Picture Experts Group (MPEG) compressing and encoding method or the like, and supplying them to the disc drive 300 through the drive controller 471.

The system controller 476 is a circuit for controlling: the drive controller 471; the video decoder 472; the audio decoder 473; and the defect management device 477, and performing the reproduction processing of the record data in cooperation with the devices, upon reproducing. Upon recording, the system controller 476 controls: the drive controller 471; the video encoder 474; the audio encoder 475; and the defect management device 477, and performing the recording processing of the record data in cooperation with the devices. Upon reproducing and recording, the system controller 476 controls the disc drive 300 (e.g. controls the generation and transmission of various request commands, the reception of a response signal, or the like) with the drive controller 471 in order to realize the cooperation of the disc drive 300 and the backend 400.

The defect management device 477 has therein a memory circuit, and has a function of receiving and holding all or part of the defect management information 120 generated or updated by the DMI generator 360 in the disc drive 300. The defect management device 477 performs the defect management with the system controller 476.

(Initial Setting Operation of Information Recording/Reproducing Apparatus)

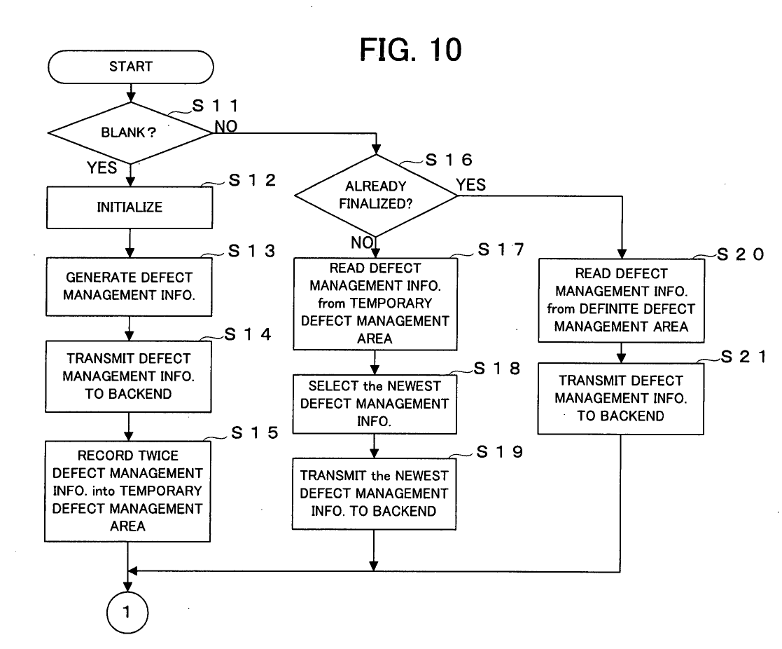

Next, the initial setting operation of the recording/reproducing apparatus 200 will be explained. FIG. 10 shows the initial setting operation of the recording/reproducing apparatus 200. The recording/reproducing apparatus 200 performs the initial setting between (i) when the optical disc 100 is inserted or loaded in the drive unit 300 and (ii) when the record data is recorded or reproduced. The initial setting is processing for preparing for the recording or reproduction of the record data, and includes various processing. Out of the processing, the initialization of the optical disc 100, the generation of the defect management information 120, the transmission of the defect management information 120 to the backend, and the like, will be explained below. The processing is performed mainly under the control of the CPU 361 of the drive unit 300.

As shown in FIG. 10, when the optical disc 100 is inserted or loaded into the drive unit 300, the CPU 361 of the drive unit 300 judges whether or not the optical disc 100 is an unrecorded disc i.e., a blank disc (step S11).

If the optical disc 100 is a blank disc (the step S11: YES), the CPU 361 initializes the optical disc 100 (step S12). In this initializing, the DMI generator 360 generates the defect management information 120 (step S13). Specifically, it obtains the start address and end address of the user data area 108 and the sizes of the spare areas 109 and 110, which are set in the initializing, and generates the setting information 121. Moreover, it generates the defect list 122. The defect list 122 generated at this time has only an outline, not having any content. Namely, the defect address is not recorded in it, nor is the specific spare address. A header, distinction information (or identification information) and the like are only recorded. The generated defect management information 120 is stored and held in the DMI generator 360.

Then, the CPU 361 transmits the defect management information 120 stored in the DMI generator 360 to the backend 400 (step S14). The defect management information 120 is stored into the defect management device 477 of the backend 400.

Then, the CPU 361 records the defect management information 120 stored in the DMI generator 360, repeatedly twice, into the temporary defect management area 104 or 105 of the optical disc 100 (step S15).

On the other hand, if the optical disc 100 is not a blank disc (the step S11: NO), the CPU 361 judges whether or not the optical disc 100 is already finalized (step S16). The finalizing is processing for arranging a recording format so that the optical disc 100 can be reproduced by a reproducing apparatus for a general rewritable optical disc and a reproducing apparatus for a general optical disc of a reproduce-only type. It is possible to recognize whether or not the optical disc 100 is already finalized by referring to the control information recorded in the lead-in area 101 or the like of the optical disc 100.

If the optical disc 100 is not finalized yet (the step S16: NO), the CPU 361 reads the defect management information 120 from the temporary defect management area 104 or 105 of the optical disc 100 (step S17). Namely, if the optical disc 100 is not a blank disc, the defect management information 120 already generated in the past is read in this step because it is recorded in the temporary defect management area 104 or 105.

Moreover, if a plurality of defect management information 120 is recorded in the temporary defect management area 104 or 105, the CPU 361 selects and reads the newest defect management information 120 among them (step S18). Namely, at a stage before the finalizing, the defect management information 120 is recorded into the temporary defect management area 104 or 105 every time it is updated. The plurality of defect management information 120 is arranged in series in the updated order. Therefore, the defect management information placed at the end is the newest defect management information in the temporary defect management area 104 or 105. The CPU 361 selects and reads the defect management information placed at the end.

In order to specify the defect management information 120 placed at the end (or the last defect management information 120), the embodiment adopts the following method. Namely, in the case where a plurality of defect management information 120 is already recorded sequentially in a row in the temporary defect management area 104 or 105, information is recorded from the start address of the temporary defect management area 104 or 105 to the end address of the area in which the last defect management information 120 is recorded, and the subsequent area is unrecorded or blank. The CPU 361 controls the optical pickup 352 and scans the temporary defect management area 104 or 105, starting from the start address. Then, it detects a position from which a blank condition starts, and scans backward the temporary defect management area 104 or 105 from the position. This is how to specify the last defect management information 120. By virtue of such a method, it is possible to easily specify the last or latest defect management information 120 without using a pointer or the like.

Then, the CPU 361 stores the read last defect management information 120 into the DMI generator 360, and transmits this information to the backend 400 (step S19). The last defect management information 120 is stored into the defect management device 477 of the backend 400.

On the other hand, if the optical disc 100 is not a blank disc but is already finalized (the step S16: YES), the CPU 361 reads the defect management information 120 from the definite defect management area 106 or 107 (step S20), and transmits this information to the backend 400 (step S21). The defect management information 120 is stored into the defect management device 477 of the backend 400.

As described above, the defect management information 120 is generated, or is selectively read from the temporary defect management area 104 or 105, or is read from the definite defect management area 106 or 107. Then, it is recorded into the DMI generator 360 and is recorded into the defect management device 477 of the backend 400. This completes the preparation for the defect management and ends the initial setting.

(Recording Operation of Information Recording/Reproducing Apparatus)

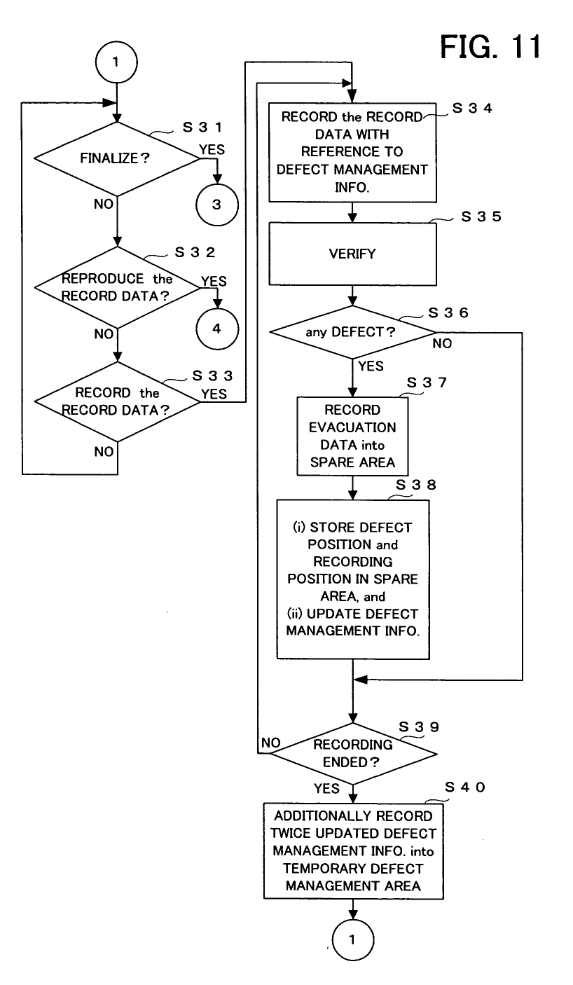

Next, the recording operation of the recording/reproducing apparatus 200 will be explained. FIG. 11 mainly shows the recording operation of the recording/reproducing apparatus 200. The recording/reproducing apparatus 200 performs the recording operation of recording the record data into the user data area 108 on the optical disc 100. The recording/reproducing apparatus 200 performs the recording operation while performing the LOW in addition to or in place of the defect management. Moreover, the recording/reproducing apparatus 200 performs verifying during the recording operation, and updates the defect list 122 on the basis of the result of the verifying. The recording operation is realized by the cooperation of the CPU 361 of the disc drive 300 and the system controller 476 of the backend 400.

As shown in FIG. 11, after it is judged whether or not instructions of finalizing, reproducing the record data, and recording the record data are given (steps S31, S32 and S33), if a user inputs an instruction of starting to record (the step S33: YES), the recording/reproducing apparatus 200 responds to this and records the record data (step S34). The record data is recorded into each predetermined block. The recording/reproducing apparatus 200 refers to the defect management information 120 stored in the defect management device 477 of the backend 400, and records the record data while performing the defect management on the basis of the information. Namely, the recording/reproducing apparatus 200 records the record data away from the position of a defect.

The recording/reproducing apparatus 200 performs verifying at each time of the one block recording (step S35), and updates the defect management information 120 on the basis of the result of the verifying. Incidentally, the defect management information 120 which is updated, is the defect management information stored in the DMI generator 360 of the drive unit 300. Specifically, if it is recognized, as a result of the verifying, that the record data fails to be recorded (step S36: YES), the CPU 361 of the disc drive 300 records the record data that fails to be recorded, i.e. the evacuation data, into the spare area 109 or 110 (step S37). Then, the CPU 361 estimates that there is a defect at a position where the record data is to be recorded, and records the defect address for indicating the position and the corresponding spare address, onto the defect list 122 (step S38).

On the other hand, as a result of the judgment in the step S36, if it is found that there is no defect at the position where the record data is to be recorded (the step S36: NO), the defect management information is not generated or updated, and the normal recording operation is continued.

When the processing in the above-described steps S34 to S38 ends with respect to a series of blocks of the record data to be recorded this time (step S39: YES), the CPU 361 records the updated defect management information 120, repeatedly twice, into the temporary defect management area 104 or 105 of the optical disc 100 (step S40). Incidentally, the defect management information 120 recorded in the temporary defect management area 104 or 105 is the defect management information stored in the DMI generator 360. Then, the recording operation is completed.

(Finalizing of Information Recording/Reproducing Apparatus)

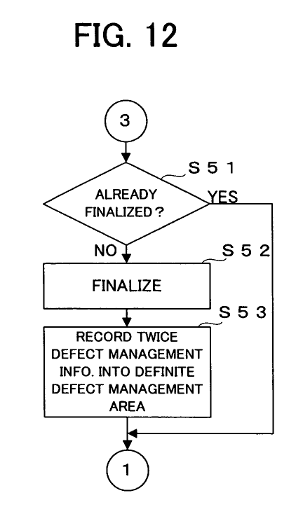

Next, the finalizing of the recording/reproducing apparatus 200 will be explained. FIG. 12 shows the finalizing of the recording/reproducing apparatus 200. For example, if the user inputs an instruction for indicating to verify (the step S31 in FIG. 11: YES), as shown in FIG. 12, the recording/reproducing apparatus 200 confirms that the optical disc 100 is not finalized yet (step S51: NO) and finalizes the optical disc 100 (step S52). Upon finalizing, the recording/reproducing apparatus 200 records the defect management information 120, repeatedly twice, into the definite defect management area 106 or 107 on the optical disc 100 (step S53). The recording may be performed once, or three time or more, i.e., a plurality of times. Incidentally, the defect management information 120 recorded in the definite defect management area 106 or 107 is the defect management information stored in the DMI generator 360. Then, the finalizing is completed.

(Reproduction Operation of Information Recording/Reproducing Apparatus)

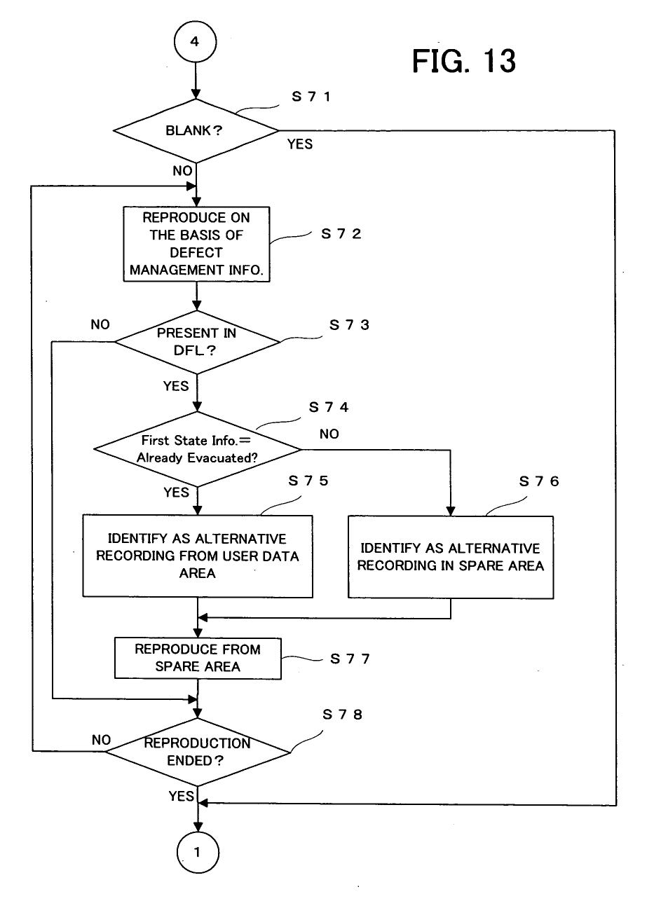

Next, the reproduction operation of the recording/reproducing apparatus 200 will be explained. FIG. 13 shows the reproduction operation of the recording/reproducing apparatus 200.

In FIG. 11, if the user inputs an instruction to start the reproduction (the step S32 in FIG. 11: YES), as shown in FIG. 13, the recording/reproducing apparatus 200 confirms that the optical disc 100 is not a blank disc (step S71: NO), and reproduces the record data recorded in the user data area 108 on the optical disc 100 (step S72). The recording/reproducing apparatus 200 reproduces the record data, while performing the defect management on the basis of the defect management information 120 stored in the defect management device 477 of the backend 400.

During the reproduction of the record data, it is judged whether or not the user data area 108, in which the reproduction is being sequentially performed, corresponds to a position which is recorded on the defect list (DFL) 122 as the evacuation source address or the alternative source address (step S73). Here, if it is judged to be the position which is recorded on the defect list (DFL) 122 as the evacuation source address or the alternative source address (the step S73: YES), it is further judged whether or not the first state information is a first condition which indicates “already evacuated”, for example (step S74). By this, it is possible to identify whether the address in the spare area 109 or 110, which is recorded on the defect list, is the evacuation source address based on the alternative (evacuative) recording of the defect management, or the alternative source address based on the alternative (evacuative) recording in the spare area. Here, if the first state information is the “first condition” (the step S74: YES), it can be identified that the relevant address is the evacuation source address based on the alternative recording of the defect management (step S75).

On the other hand, as a result of the judgment in the step S74, if the first state information is not the “first condition” but a “second condition” which indicates “cannot be used”, for example (the step S74: NO), it is possible to identify that the relevant address is the alternative source address based on the alternative recording in the spare area (step S76).

Then, the record data recorded at the position of the alternative destination address or the evacuation destination address of the defect list is reproduced (step S77).

Incidentally, if a defect is newly generated during the reproduction, the defect management is sequentially performed, in accordance with the steps S36 to S38 in FIG. 11 described above.

Then, it is judged whether or not the reproduction is ended (step S78), and if the reproduction is ended (the step S78: YES), the reproduction operation is ended. On the other hand, if the reproduction is not ended (the step S78: NO), the reproduction operation in the steps S72 to S77 is continued, on the basis of the defect management information.

### Recording Operation of Information Recording/Reproducing Apparatus in First Embodiment

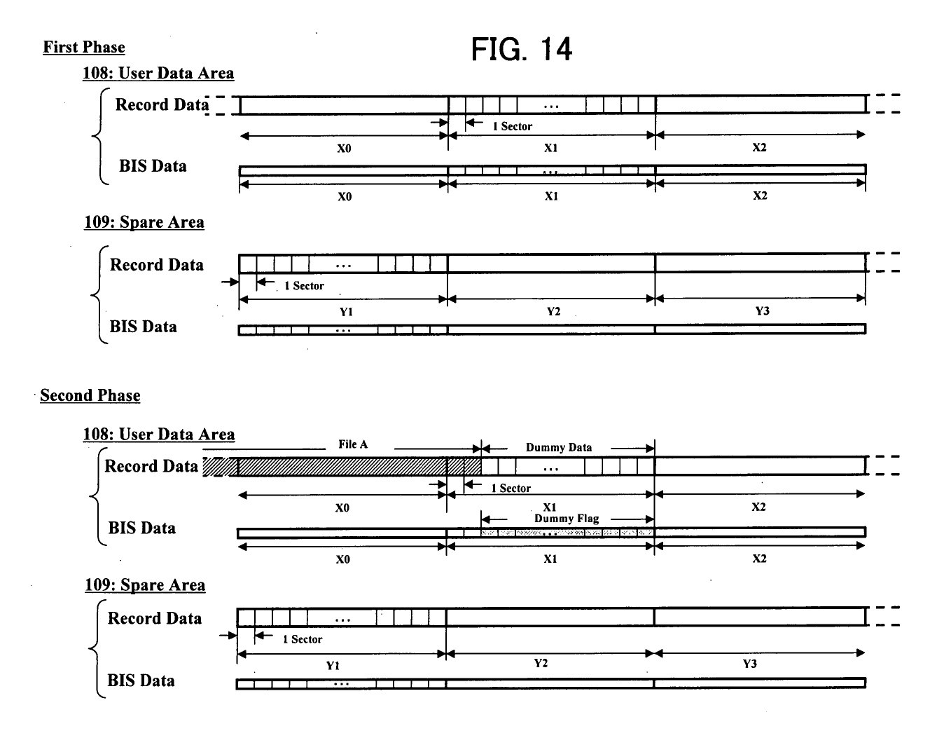

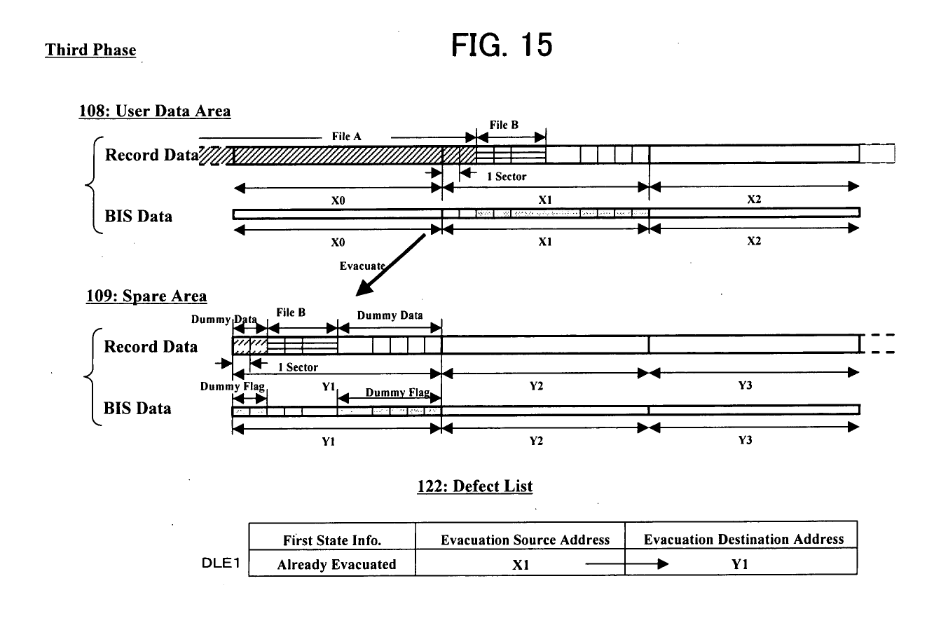

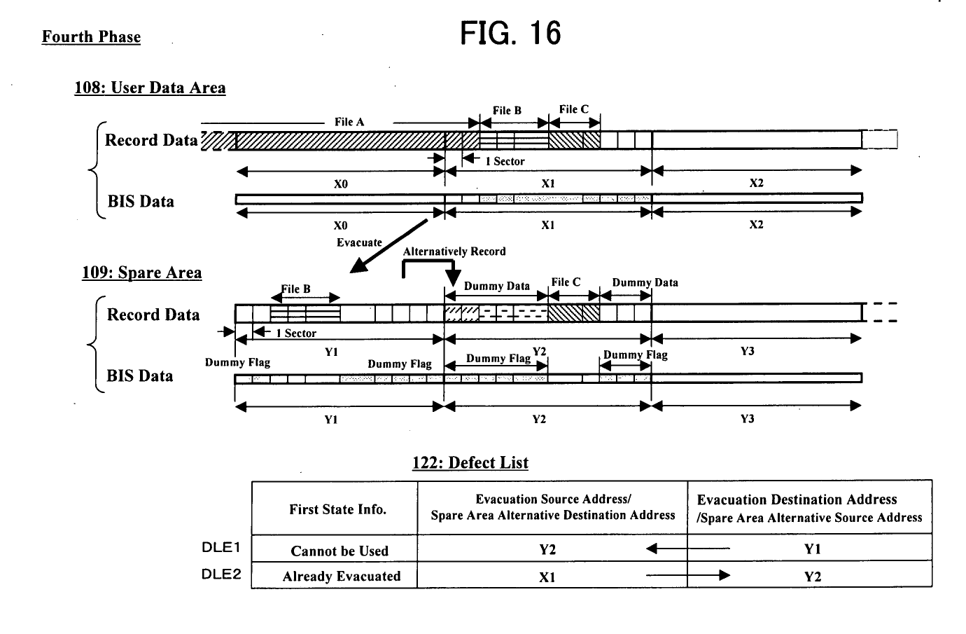

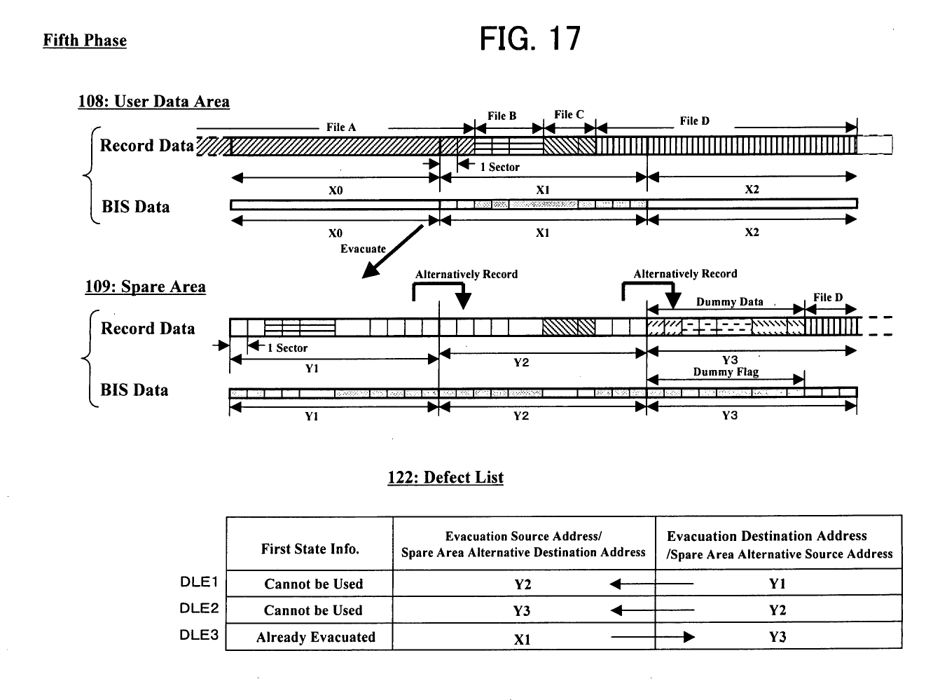

Next, with reference to FIG. 14 to FIG. 17, the recording operation in which the defect management is performed by the recording/reproducing apparatus 200 associated with the information recording/reproducing apparatus in the first embodiment of the present invention will be explained by giving one specific example. Incidentally, to make the explanation easy to understand, it is assumed that there are only the recording areas of the user data area 108 and the spare area 109 and the defect list 122 recorded in the temporary defect management area 104, on the information recording medium. Here, FIG. 14 is a conceptual diagram of a data structure, schematically showing the recording area and the defect list by the ECC block unit in first and second phases of the recording operation in which the defect management is performed by the recording/reproducing apparatus 200 associated with the information recording/reproducing apparatus in the first embodiment of the present invention. FIG. 15 is a conceptual diagram of a data structure, schematically showing the recording area and the defect list by the ECC block unit in a third phase of the recording operation in which the defect management is performed by the recording/reproducing apparatus 200 associated with the information recording/reproducing apparatus in the first embodiment of the present invention. FIG. 16 is a conceptual diagram of a data structure, schematically showing the recording area and the defect list by the ECC block unit in a fourth phase of the recording operation in which the defect management is performed by the recording/reproducing apparatus 200 associated with the information recording/reproducing apparatus in the first embodiment of the present invention. FIG. 17 is a conceptual diagram of a data structure, schematically showing the recording area and the defect list by the ECC block unit in a fifth phase of the recording operation in which the defect management is performed by the recording/reproducing apparatus 200 associated with the information recording/reproducing apparatus in the first embodiment of the present invention.

Incidentally, one defect list entry on the table of the defect list 122 in each of the phases in FIG. 15 to FIG. 17 indicates the first state information, the defect address, and the spare address, from the left side in this order, as explained in FIG. 6A and FIG. 6B. Moreover, each ECC block is provided with 16 sectors, for example. Incidentally, in each phase, addresses (i.e. ECC block numbers) of “X1” to “X3” in the user data area 108, and addresses of “Y1” to “Y3” in the spare area 109 are focused on, for convenience of explanation.

As shown in the first phase in FIG. 14, the recording areas are the spare area 109 and the user data area 108. Particularly in the first embodiment, Burst Indicator Subcode (BIS) data is shown, by which it is possible to detect an error and specify the position of a defect, correspondingly to the address of the record data which is recorded into the above recording areas. More specifically, the address or a sector number in the recording area corresponds to the BIS data, one on one. If the record data recorded in the recording area is effective, a dummy flag is not set in the BIS data. Namely, the BIS data is “0”, for example. On the other hand, if the record data recorded in the recording area is dummy data, or if it is ineffective, the dummy flag is set in the BIS data. Namely, the BIS data is “1”, for example. Moreover, one smallest block in each recording area indicates 1 sector. One large block in each recording area indicates an ECC block. In the first phase, all the recording areas are unrecorded or blank.

Next, as shown in the second phase in FIG. 14, the record data is actually recorded, with reference to the defect management information. More specifically, a file A is recorded into the whole ECC block shown by the address “X0” in the user data area 108 and into the first and second sectors of the ECC block shown by the address “X2” in the user data area 108 (refer to the hatching portion in solid right diagonal lines at the address “X0” and the address “X1”, in the record data in the user data area 108 in FIG. 14). The dummy flags are not set in the BIS data corresponding to the first and second sectors of the address “X1”, in association with the above record data. Namely, the BIS data is “0”, for example (refer to the white portion in the first and second sectors of the address “X1”, in the BIS data in the user data area 108 in FIG. 14).

On the other hand, in sectors after the third one of the ECC block shown by the address “X1”, the dummy data is recorded. In association with the dummy data, the dummy flags are set in the BIS data corresponding to the sectors after the third one of the address “X1”. Namely, the BIS data is “1”, for example (refer to the gray portion in the sectors after the third one of the address “X1”, in the BIS data in the user data area 108 in FIG. 14).

Next, as shown in the third phase in FIG. 15, it is tried to record the record data into the ECC block shown by the address “X1”, with reference to the defect management information. More specifically, it is tried to record a file B into the third to eighth sectors of the ECC block shown by the address “X1” in the user data area 108.

Here, if it is recognized that the recording/reproducing apparatus 200 fails to read the record data which is already recorded in the ECC block shown by the address “X1” in the user data area 108 in order to record the file B, the record data (the file B), i.e. the evacuation data, is recorded into the ECC block shown by the address “Y1” in the spare area 109. More specifically, the file B is recorded into the third to eighth sectors of the ECC block shown by the address “Y1” in the spare area 109 (refer to the hatching portion in solid horizontal lines in the record data at the address “Y1”, in the spare area 109 in FIG. 15). The dummy flags are not set in the BIS data corresponding to the third to eighth sectors of the address “Y1”, in association with the record data (the file B), i.e. the evacuation data. Namely, the BIS data is “0”, for example (refer to the white portion in the third to eighth sectors of the address “Y1”, in the BIS data in the spare area 109 in FIG. 15).

On the other hand, the dummy data is recorded into the first and second sectors and into sectors after the ninth one of the ECC block shown by the address “Y1”. In association with the dummy data, the dummy flags are set into the BIS data corresponding to the first and second sectors and the sectors after the ninth one of the address “Y1”. Namely, the BIS data is “1”, for example (refer to the gray portion in the first and second sectors and in the sectors after the ninth one of the address “Y1” in the BIS data in the spare area 109 in FIG. 15). More specifically, the first and second sectors of the address “Y1” in the record data in the spare area 109 in FIG. 15 (refer to the hatching portion in dotted right diagonal lines) are corresponding to a part of the data mount of the file A.

Then, the recording/reproducing apparatus 200 estimates that there is a defect at the position where the record data is to be recorded, and records both the defect address for indicating the position, i.e. the address “X1” which is the evacuation source address in the user data area 108, and the corresponding spare address, i.e. the address “Y1” which is the evacuation destination address in the spare area 109, onto the defect list 122. At the same time, the first state information in this defect list entry is recorded as “already evacuated” (refer to the defect list 122 in FIG. 15).

Next, as shown in the fourth phase in FIG. 16, it is tried to record the record data into the ECC block shown by the evacuation destination address “Y1” corresponding to the address “X1”, with reference to the defect list 122 in FIG. 15. More specifically, it is tried to record a file C into the ninth to thirteenth sectors of the ECC block shown by the address “Y1” in the spare area 109.

Here, if it is recognized that the recording/reproducing apparatus 200 fails to read the record data which is already recorded in the ECC block shown by the address “Y1” in the spare area 109 in order to record the file C, it is tried to record the record data (the file C), i.e. the evacuation data, into the ECC block shown by the address “Y2” in the spare area 109. More specifically, the file C is recorded into the ninth to thirteenth sectors of the ECC block shown by the address “Y2” in the spare area 109 (refer to the hatching portion in solid left diagonal lines in the record data at the address “Y2”, in the spare area 109 in FIG. 16). The dummy flags are not set in the BIS data corresponding to the ninth to thirteenth sectors of the address “Y2”, in association with the record data (the file C), i.e. the evacuation data. Namely, the BIS data is “0”, for example (refer to the white portion in the ninth to thirteenth sectors of the address “Y2”, in the BIS data in the spare area 109 in FIG. 16).

On the other hand, the dummy data is recorded into the first to eighth sectors and into sectors after the fourteenth one of the ECC block shown by the address “Y2”. In association with the dummy data, the dummy flags are set into the BIS data corresponding to the first to eighth sectors and the sectors after the fourteenth one of the address “Y2”. Namely, the BIS data is “1”, for example (refer to the gray portion in the first to eighth sectors and in the sectors after the fourteenth one of the address “Y2”, in the BIS data in the spare area 109 in FIG. 16). More specifically, the first and second sectors of the address “Y2” in the record data in the spare area 109 in FIG. 16 (refer to the hatching portion in dotted right diagonal lines) are corresponding to a part of the data mount of the file A. Moreover, the third to eighth sectors (refer to the hatching portion in dotted horizontal lines) are equal to the data mount of the file B.

Then, the recording/reproducing apparatus 200 estimates that there is a defect at the position where the record data is to be recorded, and records both the defect address for indicating the position, i.e. the address “X1” which is the evacuation source address in the user data area 108, and the corresponding spare address, i.e. the address “Y2” which is the evacuation destination address in the spare area 109, onto the defect list 122. At the same time, the first state information in this defect list entry is recorded as “already evacuated”.

Moreover, the recording/reproducing apparatus 200 additionally records both the defect address, i.e. the address “Y2” which is the evacuation destination address in the spare area 109, and the corresponding spare area, i.e. the address “Y1” which is the evacuation source address in the spare area 109, onto the defect list 122. This is, however, not directly related to the defect management. At the same time, the first state information in this defect list entry is recorded as “cannot be used” (refer to the defect list 122 in FIG. 16).

Next, as shown in the fifth phase in FIG. 17, it is tried to record the record data into the ECC block shown by the evacuation destination address “Y2” corresponding to the address “X1”, with reference to the defect list 122 in FIG. 16. More specifically, it is tried to record a file D into the sectors after the fourteenth one of the ECC block shown by the address “Y2” in the spare area 109.

Here, if it is recognized that the recording/reproducing apparatus 200 fails to read the record data which is already recorded in the ECC block shown by the address “Y2” in the spare area 109 in order to record the file D, it is tried to record the record data (the file D), i.e. the evacuation data, into the ECC block shown by the address “Y3” in the spare area 109. More specifically, the file D is recorded into the sectors after the fourteenth one of the ECC block shown by the address “Y3” in the spare area 109 (refer to the hatching portion in solid vertical lines in the record data at the address “Y3” in the spare area 109 in FIG. 17). The dummy flags are not set in the BIS data corresponding to the sectors after the fourteenth one of the address “Y3”, in association with the record data (the file D), i.e. the evacuation data. Namely, the BIS data is “0”, for example (refer to the white portion in the sectors after the fourteenth one of the address “Y3”, in the BIS data in the spare area 109 in FIG. 17).

On the other hand, the dummy data is recorded into the first to thirteenth sectors of the ECC block shown by the address “Y3”. In association with the dummy data, the dummy flags are set into the BIS data corresponding to the first to thirteenth sectors of the address “Y3”. Namely, the BIS data is “1”, for example (refer to the gray portion in the first to thirteenth sectors of the address “Y3”, in the BIS data in the spare area 109 in FIG. 17). More specifically, the first and second sectors of the address “Y3” in the record data in the spare area 109 in FIG. 17 (refer to the hatching portion in dotted right diagonal lines) are corresponding to a part of the data mount of the file A. Moreover, the third to eighth sectors (refer to the hatching portion in dotted horizontal lines) are equal to the data mount of the file B. Furthermore, the ninth to thirteenth sectors (refer to the hatching portion in dotted diagonal left lines) are equal to the data mount of the file C.

Then, the recording/reproducing apparatus 200 estimates that there is a defect at the position where the record data is to be recorded, and records both the defect address for indicating the position, i.e. the address “X1” which is the evacuation source address in the user data area 108, and the corresponding spare address, i.e. the address “Y3” which is the evacuation destination address in the spare area 109, onto the defect list 122. At the same time, the first state information in this defect list entry is recorded as “already evacuated”.

Moreover, the recording/reproducing apparatus 200 additionally records both the defect address, i.e. the address “Y3” which is the evacuation destination address in the spare area 109, and the corresponding spare area, i.e. the address “Y2” which is the evacuation source address in the spare area 109, onto the defect list 122. This is, however, not directly related to the defect management. At the same time, the first state information in this defect list entry is recorded as “cannot be used”.

Moreover, the recording/reproducing apparatus 200 additionally records both the defect address, i.e. the address “Y2” which is the evacuation destination address in the spare area 109, and the corresponding spare area, i.e. the address “Y1” which is the evacuation source address in the spare area 109, onto the defect list 122. This is, however, not directly related to the defect management. At the same time, the first state information in this defect list entry is recorded as “cannot be used” (refer to the defect list 122 in FIG. 17).

### Study of Operation and Effect of Information Recording/Reproducing Apparatus in First Embodiment

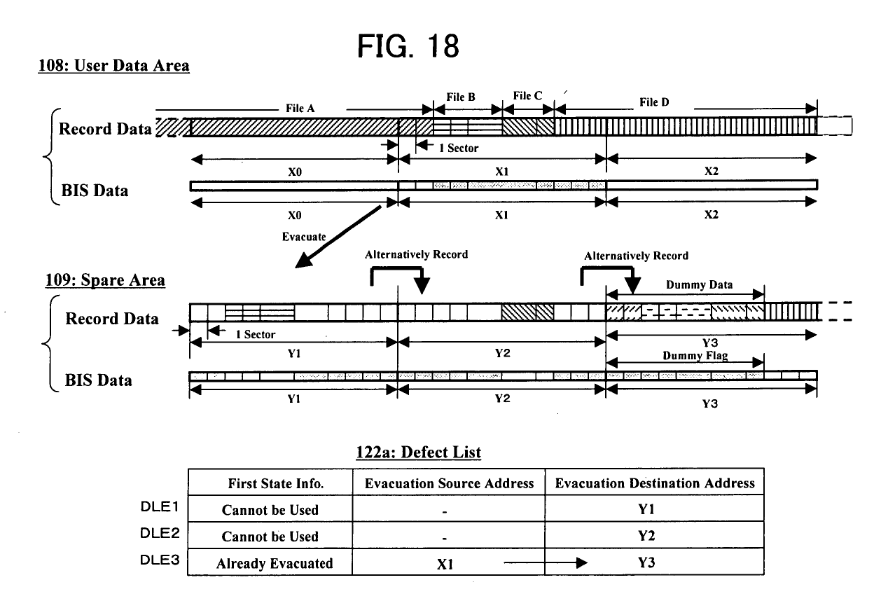

Next, with reference to FIG. 18, a study is conducted on the operation and effect of the recording operation in which the defect management is performed by the recording/reproducing apparatus 200 associated with the information recording/reproducing apparatus of the present invention. FIG. 18 is a conceptual diagram, schematically showing the recording area and the defect list by the ECC block unit in the recording operation in which the defect management is performed by the recording/reproducing apparatus 200 associated with a comparison example;

As shown in FIG. 18, in the operation of the recording/reproducing apparatus in the comparison example, the defect list entry in which the first state information is “cannot be used” holds only the information about the evacuation destination address, even if the defect list 122a is referred to. Only the newest defect list entry in which the first state information is “already evacuated” holds the information about the evacuation source address and the information about the evacuation destination address. Specifically, it is possible to identify (recognize) only the correspondence relationship between the evacuation source address “X1” and the evacuation destination address “Y3”, on the basis of the newest defect list entry.

More specifically, if the defect management is performed in the comparison example and if the file C is read with reference to the defect list 122a shown in FIG. 18, it is possible to read the data in the ECC block of the evacuation destination address “Y3” into which the data in the evacuation source address “X1” is alternatively recorded, on the basis of the newest defect list entry on the defect list. However, the dummy data is recorded in a portion corresponding to the file C in the ECC block of the evacuation destination address “Y3”. Even if the defect list 122a is referred to, it is hardly possible or impossible to go back in time and obtain the history of the alternative recording. Thus, it is impossible to read the file C which is actually recorded in the ECC block of the address “Y2”. On the contrary, in the operation of the recording/reproducing apparatus associated with the information recording/reproducing apparatus of the present invention, the newest defect list entry in which the first state information is “already evacuated” holds the information about the evacuation source address and the information about the evacuation destination address on the defect list 122, as explained in FIG. 6A, FIG. 6B and FIG. 15 to FIG. 17. In addition, even the defect list entry in which the first state information indicates “cannot be used” holds the information about the evacuation source address and the information about the evacuation destination address.

As described above, it is possible to go back in time and obtain the history of the alternative recording, with reference to the defect list, at the time of reading after the alternative processing in the case where the read error occurs in the RMW processing. Thus, if it becomes possible to reproduce the data in the ECC block which is once judged to have a defect (e.g. if it is not judged that the ECC block has a defect because of cleaned finger prints, a change in the reading condition of a recording apparatus, or for similar reasons), it is possible to reproduce again the record data which is recorded at the position of the evacuation source address (or the alternative source address) on the basis of the defect management (or the alternative recording in the spare area). Namely, because it is possible to go back in time and reproduce the record data of the past again, it is possible to increase the possibility of the successful reading of the desired record data.

More specifically, in the first embodiment, if the file C is read with reference to the defect list 122 shown in FIG. 17, it is possible to read the data in the ECC block of the evacuation destination address “Y3” into which the data in the evacuation source address “X1” is alternatively recorded, on the basis of the newest defect list entry on the defect list. Then, the dummy data is recorded in a portion corresponding to the file C in the ECC block of the evacuation destination address “Y3”. Since it is possible to go back in time and obtain the history of the alternative recording with reference to the second defect list entry DFL2 on the defect list 122, it is possible to try to read again the file C which is actually recorded in the ECC block of the address “Y2”, from the “Y2” which was judged to have a defect at the previous time. Thus, it is possible to increase the possibility of the successful reading.

### Second Embodiment of Information Recording Medium

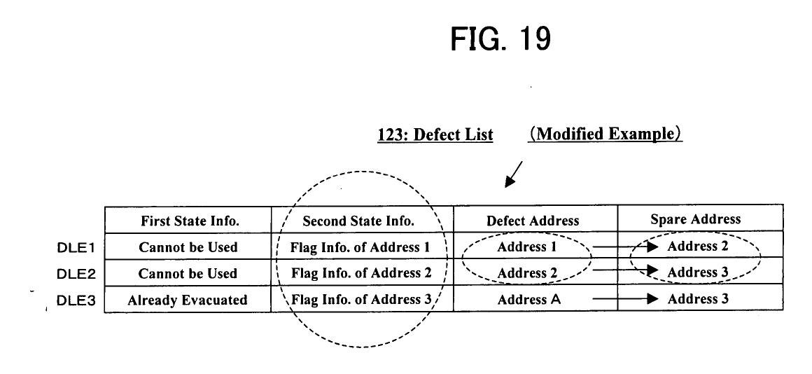

Next, an explanation is given on a defect list which is the defect management information associated with the information recording medium in the second embodiment of the present invention. FIG. 19 is a table schematically showing a data structure which is one specific example of the defect list of the defect management information in the information recording medium in the second embodiment of the present invention.

As shown in FIG. 19, in one specific example of a defect list 123 which is the defect management information in the embodiment, a group of the one “defect address”, the one “spare address”, “the first state information”, and the “second state information” is appended. Namely, the defect list entries (DLE 1 to DLE3) are appended. Specially a direction of an arrow in the defect list as shown in FIG. 19, indicates an order of accessing by the recording/reproducing apparatus 200 in the embodiment of the present invention.

The “defect address” indicates the evacuation source address in the user data area based on the defect management, or the alternative source address in the spare area based on the alternative recording in the spare area, substantially as in the explanation of the embodiment in FIG. 6B.

The “spare address” indicates the evacuation destination address in the spare area based on the defect management, or the alternative destination address in the spare area based on the alternative recording in the spare area, substantially as in the explanation of the embodiment in FIG. 6B.

The “first state information” indicates whether the defect list entry is “already evacuated” or “cannot be used”, substantially as in the explanation of the embodiment in FIG. 6B.

The “second state information” indicates dummy flag information of the BIS data which is recorded at the evacuation source address or the evacuation destination address in the spare area based on the defect management.

By reading the second state information from the defect list, it is possible to directly access the address of the desired ECC block in which the sector number is effective. Thus, it is possible to reduce an access time of accessing the desired record data, such as the files.

If the second state information is not on the defect list, as in the first embodiment, it is necessary to access the alternative source address in the spare area and read the dummy flag, in order to recognize the condition of the dummy flag. This makes the access time of accessing the desired ECC block in which the sector number is effective, relatively longer.

On the contrary, if the second state information is on the defect list, it is possible to directly access the address of the desired ECC block in which the sector number is effective, by reading the second state information from the defect list. Thus, it is possible to reduce the access time of accessing the desired record data, such as the files.

More specifically, the defect list will be explained from the lower side to the upper side. The defect list entry DLE3 is a group of an evacuation source address A in the user data area, an evacuation destination address 3 in the spare area, first state information for indicating “already evacuated”, and second state information for indicating the record state or condition, such as “already recorded” and “unrecorded”, of the evacuation destination address 3 in the spare area based on the defect management. The defect list entry DLE2 is a group of an alternative source address 2 in the spare area, an alternative destination address 3 in the spare area, first state information for indicating “cannot be used”, and second state information for indicating the record state, such as “already recorded” and “unrecorded”, of the alternative source address 2 in the spare area based on the alternative recording in the spare area. The defect list entry DLE1 is a group of an alternative source address 1 in the spare area, an alternative destination address 2 in the spare area, first state information for indicating the defect list entry “cannot be used”, and second state information for indicating the record state, such as “already recorded” and “unrecorded”, of the alternative source address 1 in the spare area based on the alternative recording in the spare area.

Incidentally, the data amount of the first state information, the method of representing the defect address and the spare address, and the like are the same as those in the first embodiment.

### Recording Operation of Information Recording/Reproducing Apparatus in Second Embodiment

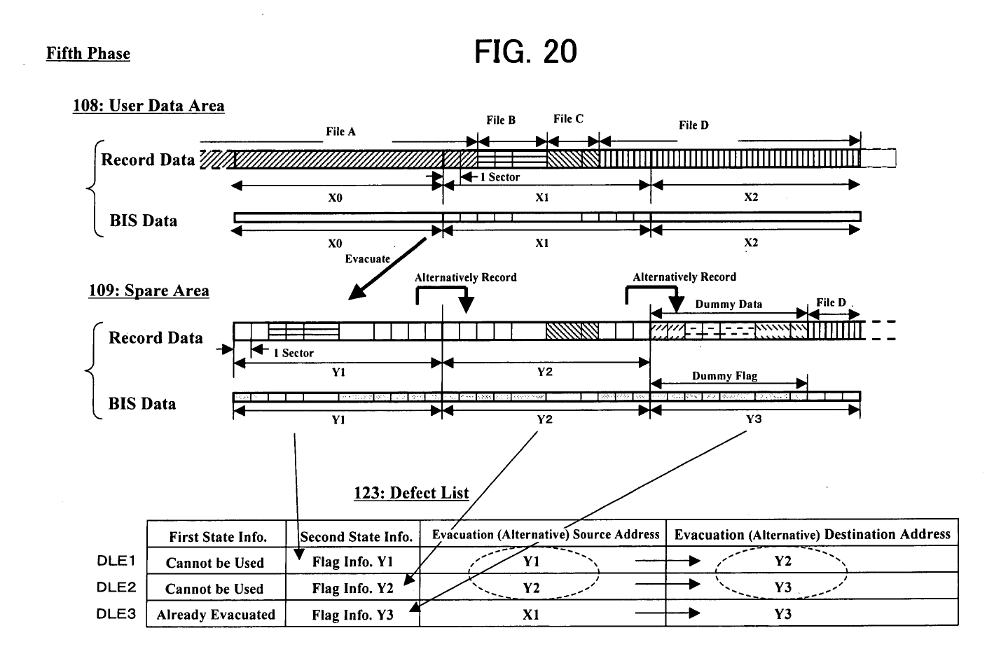

Next, with reference to FIG. 20, the recording operation in which the defect management is performed by the recording/reproducing apparatus 200 associated with the information recording/reproducing apparatus in the second embodiment of the present invention will be explained by giving one specific example. FIG. 20 is a conceptual diagram of a data structure, schematically showing the recording area and the defect list by the ECC block unit in the fifth phase of the recording operation in which the defect management is performed by the recording/reproducing apparatus 200 associated with the information recording/reproducing apparatus in the second embodiment of the present invention.

Incidentally, the data structure, which includes the user data area 109; the record data and the BIS data recorded in the user data area; the spare area 109; the record data and the BIS data recorded in the spare area; the defect list 123; and the like, is substantially the same as that in the first embodiment. Moreover, each ECC block is provided with 16 sectors, for example, as in the first embodiment. Moreover, in each phase, addresses (i.e. ECC block numbers) of “X1” to “X3” in the user data area 108, and addresses of “Y1” to “Y3” in the spare area 109 are focused on, for convenience of explanation, as in the first embodiment. Furthermore, first and second phases in the second embodiment are substantially the same as those in the first embodiment in FIG. 14. A third phase in the second embodiment is substantially the same as that in FIG. 15. A fourth phase in the second embodiment is substantially the same as that in FIG. 16.

A recording operation in a fifth phase in the second embodiment shown in FIG. 20 is substantially the same as that in the fifth phase in the first embodiment explained in FIG. 17.

After a series of recording operations for the file C based on the defect management, the recording/reproducing apparatus 200 generates the defect list 123.

Particularly, in the defect list entries DLE1, DLE2, and DLE3 on the table of the defect list 123 in the second embodiment in the fifth phase, the second state information, which is explained in FIG. 19, is appended between the first state information and the defect address.

The second state information in the defect list entry DLE1 indicates the record state of the alternative source address in the spare area based on the alternative recording in the spare area. More specifically, it indicates “1100000011111111” represented by a binary number, which is the BIS data of the address “Y1” as being the alternative source address in the spare area. By reading the second state information of the defect list entry DLE1 from the defect list, it is possible to directly access the address “Y1” at which there is the desired ECC block in which the sectors with the sector numbers of 3 to 8 are effective. Thus, it is possible to reduce the access time of accessing the desired record data which is the file B.

Moreover, the second state information in the defect list entry DLE2 indicates the record state of the alternative source address in the spare area based on the alternative recording in the spare area. More specifically, it indicates “1111111100000111” represented by a binary number, which is the BIS data of the address “Y2” as being the alternative source address in the spare area. By reading the second state information of the defect list entry DLE2 from the defect list, it is possible to directly access the address “Y2” at which there is the desired ECC block in which the sectors with the sector numbers of 9 to 13 are effective. Thus, it is possible to reduce the access time of accessing the desired record data which is the file C.

Moreover, the second state information in the defect list entry DLE3 indicates the record state of the evacuation destination address in the spare area based on the defect management. More specifically, it indicates “1111111111111000” represented by a binary number, which is the BIS data of the address “Y3” as being the evacuation destination address in the spare area. By reading the second state information of the defect list entry DLE3 from the defect list, it is possible to directly access the address “Y3” at which there is the desired ECC block in which the sectors with the sector numbers of 14 to 16 are effective. Thus, it is possible to reduce the access time of accessing the desired record data which is the file D.

Incidentally, refer to the defect list 123 in FIG. 20.

As described above, according to the recording/reproducing apparatus 200 in the embodiments, before the optical disc 100 is finalized, the defect management information 120 is recorded into the temporary defect management area 104 or 105 on the optical disc 100. When the optical disc 100 is finalized, the defect management information 120 is recorded into the definite defect management area 106 or 107 on the optical disc 100. With respect to the optical disc 100 that is not finalized, the defect management information 120 is read from the temporary defect management area 104 or 105 on the optical disc 100. With respect to the optical disc 100 that is finalized, the defect management information 120 is read from the definite defect management area 106 or 107 on the optical disc 100. By this, it is possible to realize the recording or reproduction of the record data while the appropriate defect management is performed, with respect to both the optical disc 100 that is not finalized and the optical disc 100 that is finalized.

Moreover, according to the recording/reproducing apparatus 200 in the embodiments, it is constructed such that the defect management information 120 is recorded into the definite defect management area 106 or 107 on the optical disc 100 in the finalizing. Thus, it is possible to provide the compatibility between the write-once-type optical disc 100 and a general rewritable optical disc.

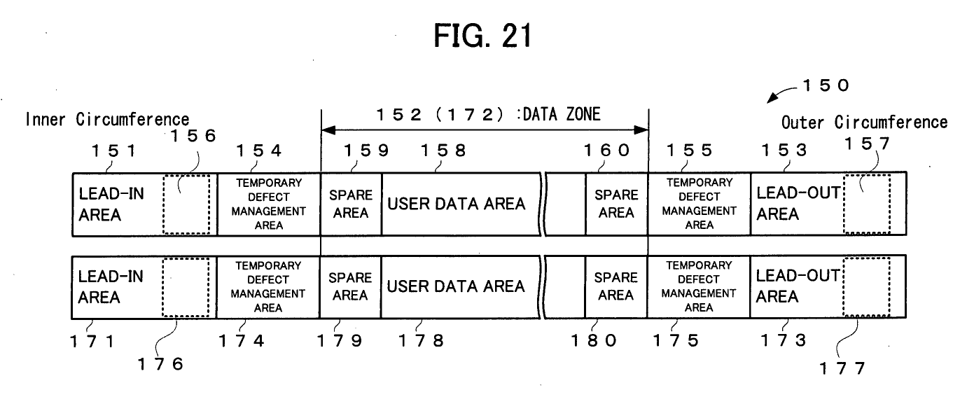

Incidentally, in the above-described embodiments, the information recording medium of the present invention is applied to a one-layer optical disc. The present invention, however, is not limited to this example, and can be also applied to a two (or more)-layer-type optical disc. FIG. 21 shows an example of the case where the information recording medium of the present invention is applied to a two-layer-type optical disc. A first layer of a two-layer-type optical disc 150 in FIG. 21 (the upper part of FIG. 21) is provided with: a lead-in area 151; a data zone 152; and a lead-out area 153, as with the optical disc 100. Moreover, the lead-in area 151 and the lead-out area 153 are provided with definite defect management areas 156 and 157, respectively. Moreover, the data zone 152 is provided with: a user data area 158; a spare area 159; and a spare area 160, as well as temporary defect management areas 154 and 155, with the user data area 158 as the center. A second layer (the lower part of FIG. 21) is provided with: a lead-in area 171; a data zone 172; and a lead-out area 173, as with the optical disc 100. The lead-in area 171 and the lead-out area 173 are provided with definite defect management areas 176 and 177, respectively. Moreover, the data zone 172 is provided with: a user data area 178; a spare area 179; and a spare area 180, as well as temporary defect management areas 174 and 175, with the user data area 178 as the center.

Moreover, according to the recording/reproducing apparatus 200 in the embodiments, it is possible to generate substantially the same defect list even in the alternative recording operation based on the LOW (Logical OverWriting) on the write-once-type information recording medium, for example, in addition to the alternative based on the defect management on the write-once-type or rewritten-type information recording medium. Here, the LOW is as follows: if the mechanism of the defect management as described above is used to record the data into the same address as that of an already-recorded position, the address of the already-recorded position is regarded as the alternative source address (or the alternate source address), and the data which will be recorded is alternatively recorded into the position of the alternative destination address (or an alternate destination address).

Incidentally, the drawings used for the explanation of the embodiments of the present invention embody constitutional elements or the like of the recording medium, recording apparatus or reproducing apparatus of the present invention only for the purpose of explaining technical ideas thereof. The shape, size, position, connection relationship, and the like of various constitutional elements or the like are not limited to the drawings.

In addition, in the above-descried embodiments, explanations are given on the optical disc 100 as one example of the recording medium and a recorder or a player associated with the optical disc 100 as one example of the recording/reproducing apparatus. The present invention, however, is not limited to the optical disc and its recorder or player, and can be applied to other various information recording media compatible with high-density recording or a high transmission rate.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-140343 filed on May 10, 2004 including the specification, claims, drawings and summary is incorporated herein by reference in its entirety.

1. An information recording medium comprising:
a user data area to record therein record data;
a spare area to alter thereto one portion of said user data area, along with defect management in said user data area; and
a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management.

2. The information recording medium according to claim 1, wherein the defect management information further includes first state information which indicates whether or not the alternative recording in said user data area or the alternative recording in said spare area is completed.

3. The information recording medium according to claim 2, wherein the defect management information indicates the first information if the first state information is in a first state, and the defect management information indicates the second information if the first state information is in a second state.

4. The information recording medium according to claim 1, wherein the defect management information further includes second state information which indicates a record state of a first position at the evacuation source address corresponding to the first information or which indicates a record state of a second position at the alternative source address corresponding to the second information.

5. The information recording medium according to claim 1, wherein said defect management area comprises a definite defect management area in addition to or in place of a temporary defect management area.

6. The information recording medium according to claim 1, further comprising a control information recording area to record therein information for controlling at least one of recording and reading into said user data area, said control information recording area including a definite defect management area to record therein defect management information of said user data area.

7. The information recording medium according to claim 1, wherein at least one of the evacuation source address, the evacuation destination address, the alternative source address, and the alternative destination address is specified by an absolute address in said user data area or a relative address based on a predetermined position.

8. A recording apparatus for recording record data onto an information recording medium comprising: (i) a user data area to record therein the record data; (ii) a spare area to alter thereto one portion of said user data area, along with defect management in said user data area; and (iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said recording apparatus comprising:
a defect management information generating device for generating or updating the defect management information; and
a recording device for recording the record data and the generated or updated defect management information.

9. The recording apparatus according to claim 8, wherein said defect management information generating device generates or updates the defect management information, by further including first state information which indicates whether or not the alternative recording in said user data area or the alternative recording in said spare area is completed.

10. The recording apparatus according to claim 8, wherein said defect management information generating device generates or updates the defect management information, by further including second state information which indicates a record state of a first position at the evacuation source address corresponding to the first information or which indicates a record state of a second position at the alternative source address corresponding to the second information.

11. The recording apparatus according to claim 8, further comprising a first recording control device for controlling said recording device to record the generated or updated defect management information into said defect management area if said defect management information generating device generates or updates the defect management information.

12. The recording apparatus according to claim 11, further comprising a defect-management-information obtaining device for reading the defect management information from said defect management area of said information recording medium and for storing the read defect management information into a memory device,
said defect management information generating device updating the defect management information stored in the memory device by said defect-management-information obtaining device if said recording device records the record data into said user data area,
said first recording control device controlling said recording device to record the defect management information into said defect management area if the defect management information is updated.

13. The recording apparatus according to claim 8, wherein
said information recording medium further comprises a control information recording area to record therein information for controlling at least one of recording and reading into said user data area, said control information recording area including a definite defect management area to record therein defect management information of said user data area, and
said recording apparatus further comprises:
a finalize-command device for giving a command for indicating to finalize said information recording medium; and
a second recording control device for controlling said recording device to record the generated or updated defect management information into said definite defect management area if said finalize-command device gives the command for indicating to finalize.

14. A recording method of recording record data onto an information recording medium comprising: (i) a user data area to record therein the record data; (ii) a spare area to alter thereto one portion of said user data area, along with defect management in said user data area; and-(iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said recording method comprising:
a defect management information generating process of generating or updating the defect management information; and
a control process of controlling a recording device to record at least one of the record data and the generated or updated defect management information.

15. A reproducing apparatus for reproducing record data recorded on an information recording medium comprising: (i) a user data area to record therein the record data; (ii) a spare area to alter thereto one portion of said user data area, along with defect management in said user data area; and (iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said reproducing apparatus comprising:
a memory device;
a reading device for reading the defect management information recorded in said defect management area and storing the read defect management information into said memory device; and
a reproducing device for reproducing the record data recorded in said user data area or the record data recorded in said spare area, on the basis of the defect management information stored in said memory device.

16. A reproducing method of reproducing record data recorded on an information recording medium comprising: (i) a user data area to record therein the record data; (ii) a spare area to alter thereto one portion of said user data area, along with defect management in said user data area; and (iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said reproducing method comprising:
a reading process of reading the defect management information recorded in said defect management area; and
a reproducing process of reproducing the record data recorded in said user data area or the record data recorded in said spare area, on the basis of the read defect management information.

17. A computer program product in a computer-readable medium for tangibly embodying a program of instructions executable by a computer in a recording apparatus to make the computer function as at least one portion of a defect management information generating device and a recording device,
said recording apparatus being for recording record data onto an information recording medium comprising: (i) a user data area to record therein the record data; (ii) a spare area to alter thereto one portion of said user data area, along with defect management in said user data area; and (iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said recording apparatus comprising:
the defect management information generating device for generating or updating the defect management information; and
the recording device for recording the record data and the generated or updated defect management information.

18. A computer program product in a computer-readable medium for tangibly embodying a program of instructions executable by a computer in a reproducing apparatus to make the computer function as at least one portion of a reading device and a reproducing device,
said reproducing apparatus being for reproducing record data recorded on an information recording medium comprising: (i) a user data area to record therein the record data; (ii) a spare area to alter thereto one portion of said user data area, along with defect management in said user data area; and (iii) a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management,
said reproducing apparatus comprising:
a memory device;
the reading device for reading the defect management information recorded in said defect management area and storing the read defect management information into said memory device; and
the reproducing device for reproducing the record data recorded in said user data area or the record data recorded in said spare area, on the basis of the defect management information stored in said memory device.

19. A data structure including a control signal, comprising:
a user data area to record therein record data;
a spare area to alter thereto one portion of said user data area, along with defect management in said user data area; and
a defect management area to record therein defect management information which includes first information and second information, the first information indicating a correspondence relationship between an evacuation source address in said user data area and an evacuation destination address in said spare area, along with alternative recording in said user data area based on the defect management, the second information indicating a correspondence relationship between an alternative source address in said spare area and an alternative destination address in said spare area, along with alternative recording in said spare area based on the defect management.
